(19) United States
(12) Patent Application Publication
(10) Pub. No.: US 2026/0156370 A1
(43) Pub. Date: Jun. 4, 2026

(54) IMAGE PROCESSING DEVICE AND METHOD FOR PROCESSING IMAGE SIGNAL

(71) Applicant: SK hynix Inc., Icheon-si (KR)

(72) Inventors: Yuuki ADACHI, Tokyo (JP); Yuta SUZUKI, Tokyo (JP)

(21) Appl. No.: 19/350,327

(22) Filed: Oct. 6, 2025

(30) Foreign Application Priority Data
Dec. 4, 2024 (KR) 10-2024-0178903

(51) Int. Cl. H04N 23/80; H04N 17/00; H04N 23/67

(52) U.S. Cl. CPC H04N 23/80; H04N 17/002; H04N 23/672

(57) ABSTRACT

An image processing device is disclosed. The image processing device includes an error calculator configured to calculate, for a first group of pixels, a first error of a first test phase difference based on a difference between the first test phase difference calculated based on the first group of pixels and a value corresponding to a lens position; a weight determiner communicatively coupled to the error calculator to receive the first error from the error calculator and configured to determine a first group of weights corresponding to the first group of pixels based on the first error; and a weight applicator communicatively coupled to the weight determiner to receive the first group of weights from the weight determiner and configured to apply the first group of weights to pixel data of the first group pixels.

### PRIORITY CLAIM AND CROSS-REFERENCE TO RELATED APPLICATION

This patent document claims the priority and benefits of Korean patent application No. 10-2024-0178903, filed on Dec. 4, 2024, the disclosure of which is incorporated herein by reference in its entirety as part of the disclosure of this patent document.

### TECHNICAL FIELD

The technology and implementations disclosed in this patent document generally relate to an image processing device for phase difference detection, and more particularly, to an image processing device capable of performing precise phase difference detection by correcting an error in a phase difference signal.

### BACKGROUND

An image sensing device captures optical images by converting light into electrical signals using a photosensitive semiconductor material that reacts to light. With advancements in industries such as automotive, medical, computer and communication industries, the demand for high-performance image sensing devices is increasing in various devices such as smartphones, digital cameras, game machines, IOT (Internet of Things), robots, security cameras and medical micro cameras.

An image processing device may have a Phase-Difference Detection Autofocus (PDAF) function that automatically adjusts the focus based on the phase difference of the detected image. For phase difference detection, some of the pixels in the pixel array may be replaced with phase difference detection pixels. For the pixel array, a predetermined number of pixels may be arranged in a matrix.

### SUMMARY

Various embodiments of the disclosed technology relate to an image sensing device having a phase-difference detection autofocus function.

Various embodiments of the disclosed technology relate to an image sensing device capable of performing the phase-difference detection autofocus function by correcting errors in the phase-difference signals.

In accordance with an embodiment of the disclosed technology, an image processing device may include an error calculator configured to calculate, for a first group of pixels, a first error of a first test phase difference based on a difference between the first test phase difference calculated based on the first group of pixels and a value corresponding to a lens position, a weight determiner communicatively coupled to the error calculator to receive the first error from the error calculator and configured to determine a first group of weights corresponding to the first group of pixels based on the first error; and a weight applicator communicatively coupled to the weight determiner to receive the first group of weights from the weight determiner and configured to apply the first group of weights to pixel data of the first group pixels.

In accordance with another embodiment of the disclosed technology, an image processing device may include an error calculator configured to calculate a first error of a first test phase difference based on phase difference data and lens position information; a weight determiner in communication with the error calculator to receive the first error and configured to determine first to fourth weights based on the first error; and a weight applicator in communication with the weight determiner to receive the first to fourth weights and configured to: apply the first weight to pixel data of a first pixel; apply the second weight to pixel data of a second pixel; apply the third weight to pixel data of a third pixel; and apply the fourth weight to pixel data of a fourth pixel.

In accordance with another embodiment of the disclosed technology, a method for processing an image signal may include calculating a test phase difference based on pixel data of a plurality of pixels; calculating an error based on a difference between a value corresponding to the test phase difference and a value corresponding to a lens position; determining a weight based on the error; and applying the weight to pixel data of the plurality of pixels.

It is to be understood that both the foregoing general description and the following detailed description of the disclosed technology are illustrative and explanatory and are intended to provide further explanation of the disclosed technology as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an image sensing device according to one embodiment of the disclosed technology.

FIG. 2 is a block diagram illustrating an image sensor according to one embodiment of the disclosed technology.

FIG. 3 is a block diagram illustrating the configuration of an image processing device according to one embodiment of the disclosed technology.

FIG. 4 is a flowchart illustrating the operation of an image processing device according to one embodiment of the disclosed technology.

FIG. 5 is a flowchart illustrating the operation of an image processing device according to one embodiment of the disclosed technology.

FIG. 6 is a diagram illustrating a microlens and multiple pixels corresponding thereto according to one embodiment of the disclosed technology.

FIG. 7 is a diagram illustrating an example of step S230 shown in FIG. 5.

FIG. 8 is a diagram illustrating an operation of calculating a test phase difference according to one embodiment of the disclosed technology.

FIG. 9 is a diagram illustrating an optical path of light incident on a pixel and a lens position.

FIG. 10A is a diagram illustrating an operation of calculating a corrected phase difference according to one embodiment of the disclosed technology.

FIG. 10B is a diagram illustrating an operation of calculating a corrected phase difference according to a microlens type ML_D corresponding to a 3×3 array according to one embodiment of the disclosed technology.

FIG. 11 is a graph depicting a linearity relationship between the phase difference and the lens position according to one embodiment of the disclosed technology.

FIG. 12 is a diagram illustrating the phase difference of an image according to one embodiment of the disclosed technology.

FIG. 13 is a block diagram illustrating an example of a computing device corresponding to the image processing device of FIG. 1.

### DETAILED DESCRIPTION

This patent document provides implementations and examples of an image processing device capable of performing precise phase difference detection by correcting an error in a phase difference signal. The disclosed implementations and examples may be used in certain configurations to substantially address one or more technical or engineering issues and to mitigate limitations or disadvantages encountered in some image signal processors in the art. Some implementations of the disclosed technology relate to an image sensing device having a phase-difference detection autofocus function. Some implementations of the disclosed technology relate to an image sensing device capable of performing the phase-difference detection autofocus function by correcting errors in the phase-difference signals. In recognition of the existing issues in the image signal processing, the suggested implementations taking into account the characteristics of pixels using microlenses. By accounting for the characteristics of microlens-equipped pixels, the accuracy of phase-difference detection can be improved even when an error occurs between the phase difference detected by the pixel and the position of the lens.

Reference will now be made in detail to some embodiments of the disclosed technology, examples of which are illustrated in the accompanying drawings. Wherever possible, the same reference numbers will be used throughout the drawings to refer to the same or like parts. While the disclosed technology is susceptible to various modifications and alternative forms, specific embodiments thereof are shown by way of example in the drawings. However, the disclosed technology should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly achieved or effectuated through various implementations of the disclosed technology.

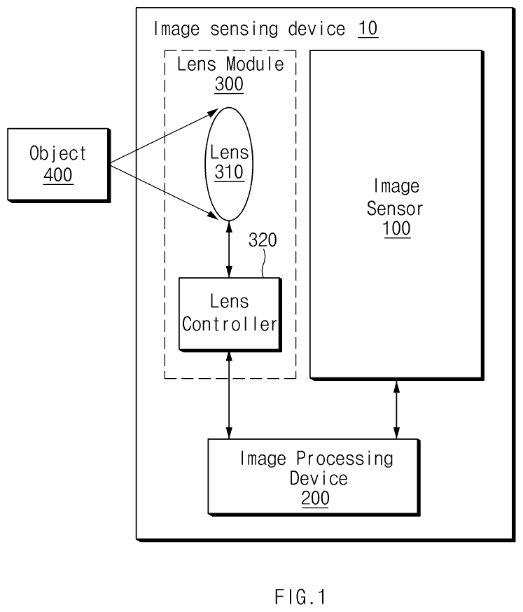

FIG. 1 is a block diagram illustrating an image sensing device according to an embodiment of the disclosed technology.

Referring to FIG. 1, the image sensing device 10 may include an image sensor 100, an image processing device 200, and a lens module 300. In one example, the lens module 300 may be a component that receives light. Specifically, the lens module 300 may include a lens 310 and a lens controller 320. The image processing device 200 may correspond to an image signal processor (ISP). For example, the image processing device 200 may include an ISP. Operations according to embodiments of the disclosed technology may be performed using the ISP.

In one embodiment, the image sensor 100 may include a pixel array. In one example, light transmitted through the lens 310 may be converted into electrical signals by pixels included in the pixel array. In one example, the pixels may be arranged in a matrix form in the pixel array. The electrical signals generated by the pixels may include an image signal and a phase signal related to an object 400. In one example, the image signal is a signal generated in response to light incident on the image sensor 100 from the object and may be used as a signal for generating an image of the object 400.

In one embodiment, the phase signal is a signal generated in response to light incident on the image sensor 100 from the object and may be used as a signal for adjusting the distance between the object 400 and the lens 310. In one example, the pixels may be classified as phase-difference detection pixels or image detection pixels according to the signals output from the pixels. The phase-difference detection pixels refer to the pixels outputting the phase signals and the image detection pixels refer to the pixels outputting the image signals. In one example, the pixel array may include phase-difference detection pixels configured to acquire phase-difference-related information to implement an autofocus function.

In one embodiment, the image sensor 100 may correspond to a sensor in which microlenses are arranged to correspond to an array of pixels arranged in one or more rows and one or more columns. For example, the pixel array may include a configuration in which multiple pixels share one microlens. In the disclosed technology, it is assumed that the image sensor 100 is of a type in which microlenses correspond to an array of pixels arranged in one or more rows and one or more columns. In one example, the image sensor 100 may include a pixel array in which multiple pixels share one microlens. In this case, the image sensor 100 may detect phase difference while capturing a color image at all pixels. For example, the operations of the image processing device 200 according to the disclosed technology may be performed based on a pixel array in which pixels arranged in a 2×2, 2× 4, 4×2, 3×3, or 4×4 matrix form share a single microlens.

In one embodiment, the image processing device 200 may perform at least one image signal process on image data to generate the processed image data. The image processing device 200 may reduce noise of image data, and may perform various kinds of image signal processing (e.g., demosaicing, defect pixel correction, gamma correction, color filter array interpolation, color matrix, color correction, color enhancement, lens distortion correction, etc.) for image-quality improvement of the image data. In addition, the image processing device 200 may compress image data that has been created by execution of image signal processing for image-quality improvement, such that the image processing device 200 can create an image file using the compressed image data. Alternatively, the image processing device 200 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, multiple frames can be compressed according to Moving Picture Experts Group (MPEG) standards such that moving image files can be created.

In one embodiment, the image data may be generated by an image sensing device 10 that captures an optical image of a scene, but other implementations are also possible. The image sensing device 10 may include a pixel array including multiple pixels configured to sense incident light received from a scene, a control circuit configured to control the pixel array, and a readout circuit configured to output digital image data by converting an analog pixel signal received from the pixel array into the digital image data. In some embodiments of the disclosed technology, it is assumed that the image data is generated by the image sensing device 10.

In one embodiment, the image processing device 200 may provide information related to focus detection to the lens controller 320 based on the image signal. In one example, when there is no phase difference between the signals generated from the pixels included in the image sensor 100, the distance between the lens 310 and the object 400 may correspond to an in-focus position. In one example, when the distance between the lens 310 and the object 400 does not correspond to the in-focus position, there may be a difference between the signals generated from the pixels.

In one embodiment, the image processing device 200 may analyze the difference between the signals and provide a lens control signal (LCS) to the lens controller 320. In one example, the lens controller 320 may move the lens 310 such that the distance between the lens 310 and the object 400 corresponds to the in-focus position, based on the LCS provided by the image processing device 200.

In one embodiment, the image processing device 200 may obtain phase information and image information based on the signals output from the pixels. In one example, the image processing device 200 may control the operation of the image sensing device 10. For example, the image processing device 200 may provide control signals for the respective components of the lens module 300 based on the image signals received from the image sensor 100.

In one embodiment, the image processing device 200 may receive phase signals from the image sensor 100 and calculate a phase difference. For example, the image processing device 200 may calculate the phase difference based on phase information obtained from any two pixels among the pixels arranged in a 2×2 matrix. In one example, based on the phase difference calculation, the image processing device 200 may determine the position and orientation of the focus, and the distance between the object 400 and the image sensing device 10. In one example, the image processing device 200 may output an LCS to the lens controller 320 based on the result of the phase difference calculation.

In one embodiment, the image processing device 200 may also perform image signal processing for enhancement of the image quality, such as noise correction for the image information and interpolation between adjacent pixels, as well as the operations described above.

In one embodiment, the lens 310 may be implemented as a single lens or multiple lenses. While FIG. 1 shows the single lens, a lens assembly can be provided, which includes multiple lenses. As the position of the lens 310 is adjusted, the focus on the object 400 may change. The position of the lens 310 may be adjusted by the lens controller 320 based on the signals generated from the pixels of the image sensor 100. The range of the incident angle of marginal rays with respect to the optical axis of the lens 310 used in the image sensing device 10 for mobile devices may be preset. In one example, the range of the incident angle of marginal rays with respect to the optical axis of the lens 310 may be ±10°. In one example, a marginal ray may refer to a ray that intersects with the object 400 on the optical axis and passes through the edge of the aperture. Therefore, the phase-difference detection by the image sensing device 10 may be measured based on the incident light that is incident on the lens 310 within a narrower range of the incident angle than the marginal rays.

In one embodiment, the lens controller 320 may control the position of the lens 310 in accordance with control signals from the image processing device 200. Specifically, the lens controller 320 may adjust the distance between the lens 310 and the object 400. In one example, the lens controller 320 may measure the distance between the image sensor 100 and the lens 310 and transmit the measured value to the image processing device 200.

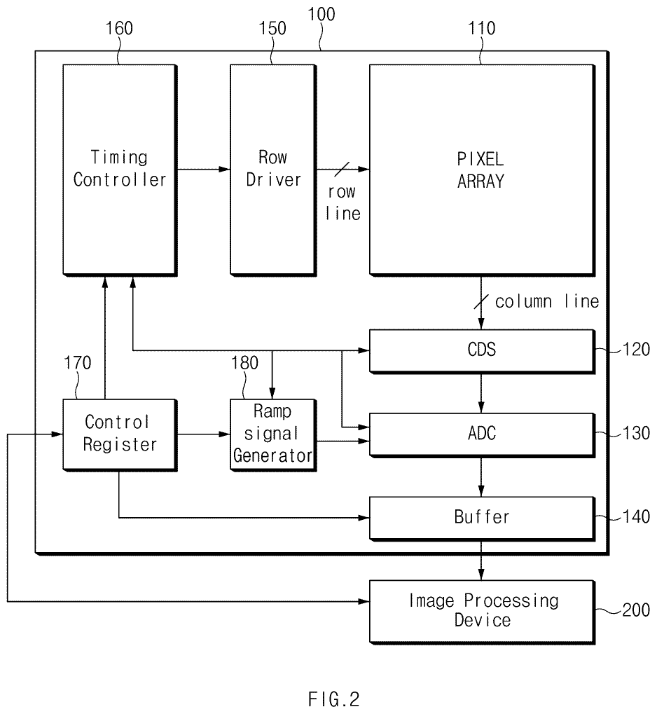

FIG. 2 is a block diagram illustrating an image sensor according to one embodiment of the disclosed technology.

Referring to FIGS. 1 and 2, the image sensor 100 according to one embodiment of the disclosed technology may include a pixel array 110 including multiple pixels arranged in a matrix form, a correlated double sampler (CDS) 120, an analog-to-digital converter (ADC) 130, a buffer 140, a row driver 150, a timing controller 160, a control register 170, and a ramp signal generator 180.

In one embodiment, the image processing device 200 may receive an output signal of the buffer 140, such that the image processing device 200 may fabricate, process, and/or calculate the image.

In one embodiment, the pixel array 110 may include pixel groups each including multiple pixels arranged to correspond to a single microlens. The optical signal passing through the lens 310 may be imaged by the pixel array 110 and converted into an electrical signal. In one example, the image detection pixels or phase detection pixels included in the pixel array 110 may absorb light to generate electric charges and provide electrical signals corresponding to the generated charges to the CDS 120.

In one embodiment, the pixels may generate signals corresponding to the object 400 in FIG. 1. In one example, the pixels may capture an image of the object 400 and generate phase signals. The phase signals may be transmitted to the image processing device 200 and be used to detect the distance between the object 400 and the lens 310. In one example, the multiple pixels included in the pixel array 110 may be arranged in one or more rows and one or more columns and may share a single microlens.

In one embodiment, the phase signals may include information about the positions of the pixels in the pixel array 110 that generate the phase signals. In one example, the image processing device 200 may calculate a phase difference and compute the in-focus position of the lens (e.g., the lens 310) based on the phase difference. For example, the position of the lens (e.g., the lens 310) at which the phase difference between the phase signals detected from the pixels arranged in a 2×2 matrix corresponding to a single microlens becomes zero may be referred to as the in-focus position. In one example, the pixels that detect the phase signals may be used to generate an image signal of the object 400.

The CDS 120 may sample and hold electrical signals received from the pixel array 110. The CDS 120 may perform double sampling of a signal level caused by incident light and a specific noise level, and may output a signal level corresponding to a difference between the sampling resultant signals. For example, the CDS 120 may perform sampling of a reference voltage level and a voltage level of the received pixel signal in response to a clock signal received from the timing controller 160, and may transmit an analog signal corresponding to a difference between the reference voltage level and the voltage level of the received pixel signal to the ADC 130.

The ADC 130 may convert the analog signal received from the CDS 120 into a digital signal, and may transmit the digital signal to the buffer 140. In one example, the ADC 130 may compare a ramp signal output from the ramp signal generator 180 with the sampling signal output from the CDS 120, and may generate a comparison signal. In one example, the ADC 130 may count a level transition time of the comparison signal based on a clock signal received from the timing controller 160, and may output a count value to the buffer 140.

The buffer 140 may latch the digital signals received from the buffer 140, and may sequentially output the latched digital signals to the image processing device 200. The buffer 140 may include a memory for latching the digital signal and a sensing amplifier for amplifying the digital signal.

In one embodiment, the row driver 150 may drive multiple pixels included in the pixel array 110 based on signals from the timing controller 160. For example, the row driver 150 may generate a selection signal for selecting one of multiple row lines. In one example, the row driver 150 may generate signals for driving transistors included in the pixels (e.g., a transfer transistor drive signal, a reset transistor drive signal, and a select transistor drive signal). In one example, the row driver 150 may generate selection signals or drive signals for multiple pixels for detection of the phase difference, based on whether the autofocus function is being performed.

In one embodiment, the timing controller 160 may control the row driver 150, such that the pixel array 110 can generate charges by absorbing light, can temporarily store the generated charges, or can output an electrical signal corresponding to the stored charges to the outside of the pixel array 110. In one example, the timing controller 160 may control the CDS 120 to sample and hold electrical signals provided by the pixel array 110. For example, the timing controller 160 may generate timing signals to control the operations of the row driver 150, the CDS 120, the ADC 130, and the ramp signal generator 180.

In one embodiment, the control register 170 may generate control signals to control the buffer 140, the timing controller 160, and the ramp signal generator 180 based on the signal received from the image processing device 200.

In one embodiment, the ramp signal generator 180 may generate a ramp signal that enables the ADC 130 to detect a signal under control of the timing controller 160.

In one embodiment, the image processing device 200 may receive an output signal of the buffer 140 as an input, and calculate phase information or image information based on the received signal to generate a signal. For example, the image processing device 200 may drive an aperture of the image sensing device 10 using an image signal, or may provide a control signal to the lens controller 320 using a phase signal. For example, the control register 170 may generate the above control signals based on signals received from the image processing device 200.

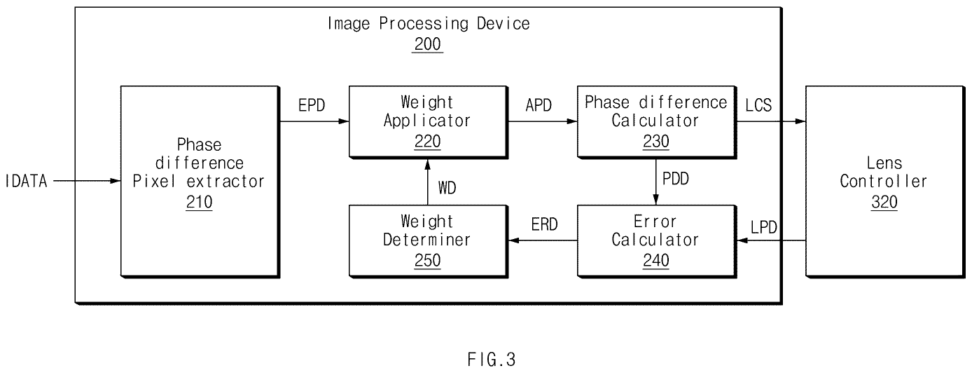

FIG. 3 is a block diagram illustrating the configuration of an image processing device according to one embodiment of the disclosed technology.

Referring to FIG. 3, the image processing device 200 may include a phase difference pixel extractor 210, a weight applicator 220, a phase difference calculator 230, an error calculator 240, and a weight determiner 250. In one example, the image processing device 200 may receive image data (IDATA) from the image sensor 100. In one example, based on the operations of the phase difference pixel extractor 210, the weight applicator 220, the phase difference calculator 230, the error calculator 240, and the weight determiner 250 mentioned above, the image processing device 200 may generate a lens control signal (LCS). The configuration of the image processing device 200 as shown in FIG. 3 is merely one example, and some components may be added or omitted. For example, the phase difference pixel extractor 210 and the phase difference calculator 230 may be omitted from the image processing device 200. For example, the phase difference pixel extractor 210 and the phase difference calculator 230 may be included in an external module of the image processing device 200.

In one embodiment, the phase difference pixel extractor 210 may identify first multiple pixels. The first multiple pixels may be also referred to as a first group of pixels. The phase difference pixel extractor 210 may receive the image data (IDATA) from the image sensor. For example, based on the image data (IDATA) received from the image sensor 100, the phase difference pixel extractor 210 may identify pixel data of the phase difference pixels based on the phase. In one example, the phase difference pixel extractor 210 may transmit the pixel data (EPD) related to the identified pixels to the weight applicator 220. For example, based on the pixel data of the pixels positioned in a first channel of a microlens and the pixels positioned in a third channel of the microlens, the phase difference pixel extractor 210 may identify a left image. Also, based on the pixel data of the pixels positioned in a second channel of the microlens and the pixels positioned in a fourth channel of the microlens, the phase difference pixel extractor 210 may identify a right image. The first to fourth channels of the microlens may refer to the specific areas of a micro-lens that correspond to different pixels used for phase detection autofocus. In one example, the image data (IDATA) may include pixel data of pixels corresponding to a first phase and pixel data of pixels corresponding to a second phase. A phase difference image may be generated based on the pixel data of the pixels corresponding to the first phase and the pixel data of the pixels corresponding to the second phase.

In one embodiment, the phase difference pixel extractor 210 may identify first to fourth pixels sharing a microlens. The first pixel may be positioned in a first channel corresponding to the upper left side of the microlens, and the second pixel may be positioned in a second channel corresponding to the upper right side. The third pixel may be positioned in a third channel corresponding to the lower left side, and the fourth pixel may be positioned in a fourth channel corresponding to the lower right side. These channels and their pixels are used by the phase difference pixel extractor 210 to identify pixel data based on the phase.

In one embodiment, the weight applicator 220 may apply a weight to the pixels identified by the phase difference pixel extractor 210. For example, the weight applicator 220 may adjust the pixel data (EPD) related to the identified pixels and transmit the adjusted pixel data (APD) to the phase difference calculator 230. The weight applicator 220 may be configured to perform: i) an operation of skipping application of a weight to the pixels identified by the phase difference pixel extractor 210, ii) an operation of applying a preset weight to the pixels, or iii) an operation of applying a weight determined by the weight determiner 250 to the pixels. For example, the adjusted pixel data (APD) may include pixel data obtained by skipping application of a weight to the pixel data (EPD) received by the weight applicator 220, pixel data obtained by applying the preset weight to the pixel data (EPD), or pixel data obtained by applying the weight determined by the weight determiner 250 to the pixel data (EPD).

In one embodiment, the weight applicator 220 may skip application of a weight to the pixels identified by the phase difference pixel extractor 210. In one example, the weight applicator 220 may transmit the pixel data of the pixels identified by the phase difference pixel extractor 210 to the phase difference calculator 230. For example, the weight applicator 220 may multiply the pixel data of the pixels identified by the phase difference pixel extractor 210 by 1 as a weight.

In one embodiment, the weight applicator 220 may apply a preset weight to the pixels identified by the phase difference pixel extractor 210. For example, the image processing device 200 may further include a memory (not shown), and the weight applicator 220 may multiply the pixel data of the pixels identified by the phase difference pixel extractor 210 by a weight stored in the memory.

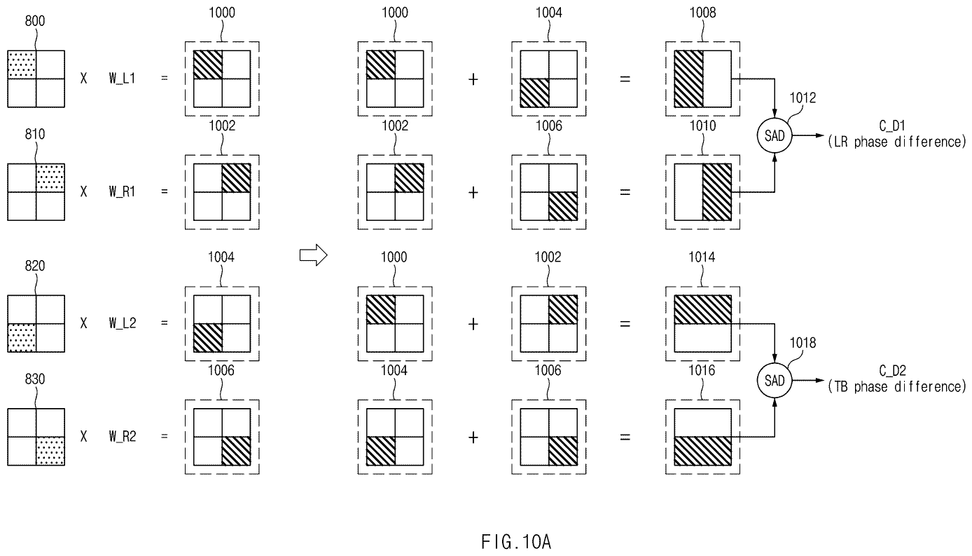

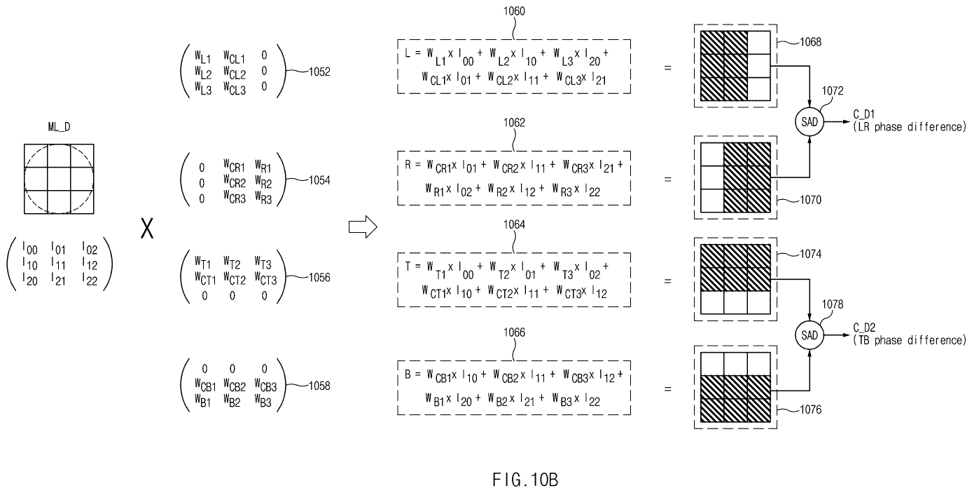

In one example, the weight applicator 220 may apply a weight determined by the weight determiner 250 to the pixel data of the pixels identified by the phase difference pixel extractor 210. For example, the weight applicator 220 may apply the first to fourth weights determined by the weight determiner 250 to the pixel data of the first to fourth pixels, respectively. For example, the weight applicator 220 may be communicatively coupled to the weight determiner 250, and the weight applicator 220 may multiply the pixel data of the first pixel by the first weight, the pixel data of the second pixel by the second weight, the pixel data of the third pixel by the third weight, and the pixel data of the fourth pixel by the fourth weight. A detailed description of the operation of the weight applicator 220 will be provided later in this document with reference to FIG. 10A.

In one embodiment, the phase difference calculator 230 may generate a phase difference image based on the adjusted pixel data (APD) received from the weight applicator 220, and calculate a phase difference based on the phase difference image. In one example, the phase difference calculator 230 may transmit a lens control signal (LCS) to the lens controller 320 and transmit phase difference data (PDD) to the error calculator 240. In one example, the phase difference data (PDD) may include test phase difference data or corrected phase difference data. For example, phase difference data generated based on pixel data to which no weight is applied or pixel data to which with a preset weight is applied may correspond to the test phase difference. For example, phase difference data generated based on pixel data to which the weight (WD) determined by the weight determiner 250 is applied may correspond to the corrected phase difference.

In one embodiment, the phase difference calculator 230 may generate an uncorrected left-right phase difference image or an uncorrected up-down phase difference image based on the pixel data of the first multiple pixels multiplied by a preset weight. The phase difference calculator 230 may calculate a test phase difference based on the uncorrected left-right phase difference image or the uncorrected up-down phase difference image.

In one embodiment, the test phase difference may correspond to the phase difference calculated by the phase difference calculator 230 based on the pixel data (EPD) of the pixels extracted by the phase difference pixel extractor 210. For example, the phase difference pixel extractor 210 may identify first to fourth pixels sharing one microlens. In this case, the phase difference calculator 230 may identify the pixel data of the first to fourth pixels corresponding to the current lens position of the image sensing device 10 or a preset lens position, and may generate or extract a left-right phase difference image or an up-down phase difference image based on the identified pixel data. Here, the phase difference may correspond to the disparity of the left-right phase difference image or the up-down phase difference image. The phase difference calculator 230 may calculate the test phase difference based on the extracted left-right or up-down phase difference image.

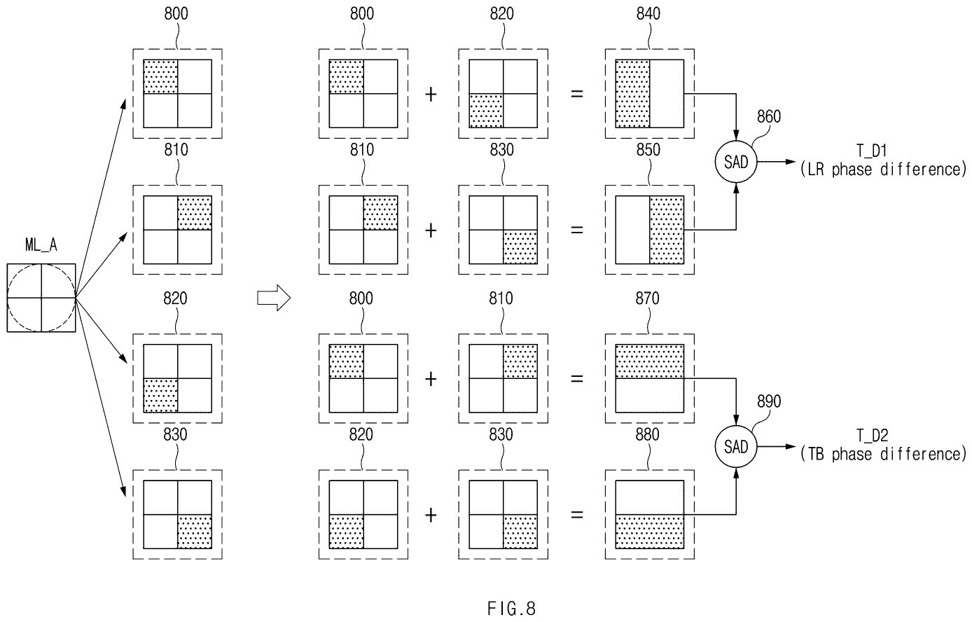

In one embodiment, the phase difference calculator 230 may generate a corrected left-right phase difference image or corrected up-down phase difference image based on the pixel data of the first to fourth pixels multiplied by first to fourth weights. The phase difference calculator 230 may calculate a corrected phase difference based on the corrected left-right or up-down phase difference image. A more detailed description of the operation of the phase difference calculator 230 will be provided later with reference to FIG. 8.

In one embodiment, the error calculator 240 may calculate an error based on the phase difference data (PDD) received from the phase difference calculator 230 and lens position information (LPD) received from the lens controller 320, and transmit the calculated error (ERD) to the weight determiner 250. For example, the error calculator 240 may calculate a first error of a first test phase difference based on a difference between the first test phase difference calculated by the phase difference calculator 230 and the lens position calculated by the lens controller 320. In one example, the error calculator 240 may be communicatively coupled to the weight determiner 250, and the error calculator 240 may transmit the calculated error (ERD) to the weight determiner 250.

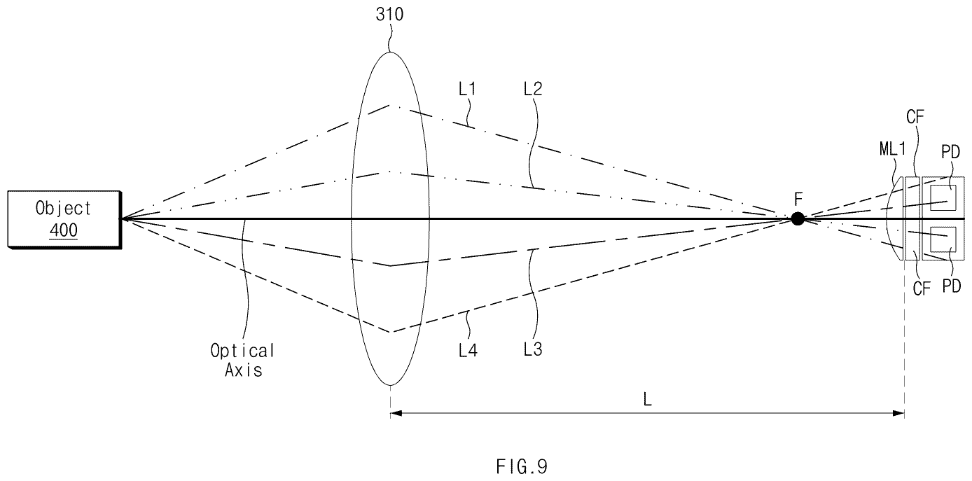

In one embodiment, the lens position may be calculated by the lens controller 320. For example, the lens position may correspond to the distance between one surface of the pixel array and the central cross-section of the lens (e.g., the lens 310) parallel to the one surface of the pixel array. For example, the lens position may correspond to the distance between the center point of the lens (e.g., the lens 310) and the point where the optical axis meets the pixel array. In one example, the lens position may be adjusted by the lens controller 320. In one example, the lens controller 320 may calculate the lens position adjusted by the lens controller 320 and transmit the calculated lens position information (LPD) to the error calculator 240. A more detailed description of the operation for calculating the lens position will be provided later with reference to FIG. 9.

In one embodiment, the first error may be calculated by the error calculator 240 based on the first test phase difference and the lens position. In one example, the first error may correspond to the difference between a value obtained by applying a sensor-specific parameter or correction coefficient to the first test phase difference calculated by the phase difference calculator 230 and a value corresponding to the lens position calculated by the lens controller 320. In one example, the sensor-specific parameter or correction coefficient may correspond to a preset value.

In one embodiment, the first error may be calculated as shown in Equation 1. In Equation 1, “e” may correspond to the first error, “d” may correspond to the first test phase difference, “l” may correspond to the lens position, “α” may correspond to a sensor-specific parameter, “a” may correspond to a first coefficient, and “b” may correspond to a second coefficient.

$$e = \vert d - α ( al + b ) \vert \qquad [ Equation 1 ]$$

In one embodiment, the weight determiner 250 may determine weights based on the error data (ERD) received from the error calculator 240 and transmit the determined weight data (WD) to the weight applicator 220. In one example, the weight determiner 250 may determine first to fourth weights based on a first error calculated by the error calculator 240. In one example, the first to fourth weights may correspond to correction weights that minimize the first error. For example, the weight determiner 250 may calculate optimal first to fourth weights to minimize the first error. In one example, by applying the first to fourth weights to the pixel data of the first to fourth pixels, the first error may be minimized.

In one embodiment, the first weight may be applied to the first pixel located at the upper left side of the first microlens, the second weight may be applied to the second pixel located at the upper right side of the first microlens, the third weight may be applied to the third pixel located at the lower left side of the first microlens, and the fourth weight may be applied to the fourth pixel located at the lower right side of the first microlens.

In one embodiment, the first to fourth weights may be calculated using Equations 2 to 5. In Equations 2 to 5, W_{L1} may correspond to the first weight, W_{R1} may correspond to the second weight, W_{L2} may correspond to the third weight, W_{R2} may correspond to the fourth weight, a₁ may correspond to a first weight coefficient, a₂ may correspond to a second weight coefficient, I₀₀ may correspond to the first pixel, I₁₀ may correspond to the second pixel, I₀₁ may correspond to the third pixel, I₁₁ may correspond to the fourth pixel, I(L) may correspond to the left image, and I(R) may correspond to the right image.

$${W}_{L 1} or {W}_{R 1} = 0.5 + 0.5 {a}_{1} \qquad [ Equation 2 ]$$

$${W}_{L 2} or {W}_{R 2} = 0.5 + 0.5 {a}_{2} \qquad [ Equation 3 ]$$

$$I ( L ) = {w}_{L 1} {I}_{00} + {W}_{L 2} {I}_{10} \qquad [ Equation 4 ]$$

$$I ( R ) = {w}_{R 1} {I}_{01} + {W}_{R 2} {I}_{01} \qquad [ Equation 5 ]$$

In one embodiment, the first to fourth weights may be adjusted to reduce the first error by varying the value of the first weight coefficient (e.g., a₁) or the second weight coefficient (e.g., a₂). For example, the first weight coefficient (e.g., a₁) or the second weight coefficient (e.g., a₂) may include an equation that includes the first error.

In one embodiment, the first to fourth weights may be calculated using Equations 6 to 9. In Equations 6 to 9, W_{T1} may correspond to the first weight, W_{B1} may correspond to the second weight, W_{T2} may correspond to the third weight, W_{B2} may correspond to the fourth weight, a₁ may correspond to a first weight coefficient, a₂ may correspond to a second weight coefficient, I₀₀ may correspond to the first pixel, I₁₀ may correspond to the second pixel, I₀₁ may correspond to the third pixel, I₁₁ may correspond to the fourth pixel, I(T) may correspond to the upper image, and I(B) may correspond to the lower image.

$${w}_{T 1} or {w}_{B 1} = 0.5 + 0.5 {a}_{1} \qquad [ Equation 6 ]$$

$${w}_{T 2} or {w}_{B 2} = 0.5 + 0.5 {a}_{2} \qquad [ Equation 7 ]$$

$$I ( T ) = {w}_{T 1} {I}_{00} + {W}_{T 2} {I}_{10} \qquad [ Equation 8 ]$$

$$I ( B ) = {w}_{B 1} {I}_{01} + {W}_{B 2} {I}_{01} \qquad [ Equation 9 ]$$

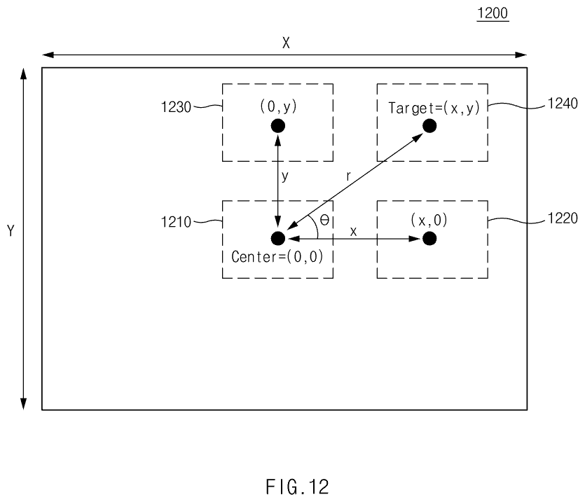

In one embodiment, the first to fourth weights may be adjusted to reduce the first error by varying the value of the first weight coefficient (e.g., a₁) or the second weight coefficient (e.g., a₂). For example, the first weight coefficient (e.g., a₁) or the second weight coefficient (e.g., a₂) may include an equation that includes the first error. A more detailed description of the operation of the weight determiner 250 will be provided later with reference to FIG. 12.

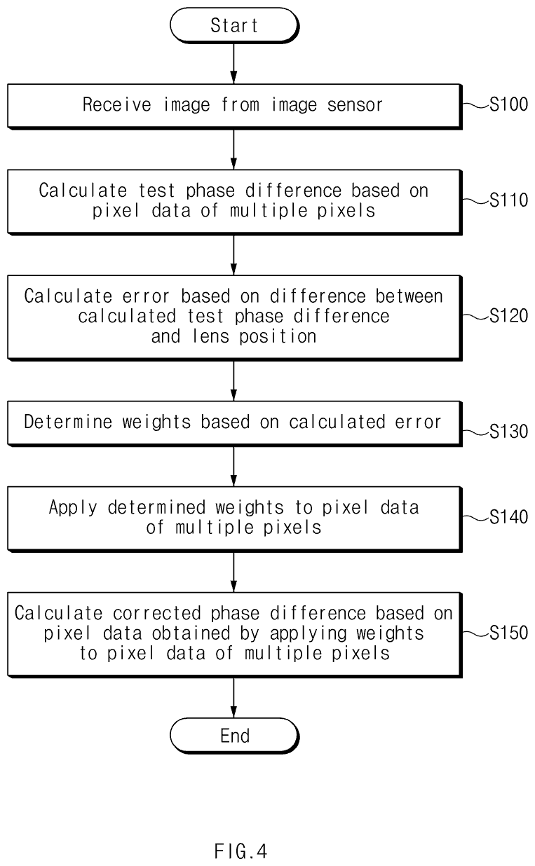

FIG. 4 is a flowchart illustrating the operation of an image processing device according to one embodiment of the disclosed technology.

Referring to FIG. 4, the image processing device 200 may receive an image from the image sensor 100 (S100). In one example, the image processing device 200 may receive image data (IDATA) from the image sensor 100. The image data (IDATA) may be mapped to correspond to coordinates of the pixel array. In one example, a unit pixel group may be positioned in at least one region of the pixel array. For example, a first pixel group including first to fourth pixels sharing a first microlens may be positioned in a first region of the pixel array.

In one embodiment, the image data (IDATA) may include pixel data of pixels included in each pixel group corresponding to at least one region of the pixel array. For example, for the pixel group positioned in the first region of the pixel array, the image data (IDATA) may include pixel data of the first pixel, pixel data of the second pixel, pixel data of the third pixel, and pixel data of the fourth pixel. The pixel data may refer to any information associated with a corresponding pixel. In one example, the first pixel may be positioned in a first channel of the first microlens, the second pixel in a second channel of the first microlens, the third pixel in the third channel of the first microlens, and the fourth pixel in the fourth channel of the first microlens.

In one embodiment, the image processing device 200 may identify phase information based on the multiple pixels included in the first pixel group. For example, the first pixel may be positioned in the first channel corresponding to the upper left side of the first microlens, the second pixel in the second channel corresponding to the upper right side of the first microlens, the third pixel in the third channel corresponding to the lower left side of the first microlens, and the fourth pixel in the fourth channel corresponding to the lower right side of the first microlens. The image processing device 200 may calculate the phase difference based on a phase difference image generated by combining the pixel data of the first to fourth pixels.

In one embodiment, the phase difference calculator (e.g., the phase difference calculator 230) of the image processing device 200 may calculate a test phase difference based on the pixel data of the multiple pixels (S110). In one example, the phase difference calculator (e.g., the phase difference calculator 230) may extract a left-right image or an up-down image based on the pixel data of the multiple pixels. Then, the phase difference calculator (e.g., the phase difference calculator 230) may calculate the phase difference based on the disparity of the extracted left-right image or up-down image. For example, regarding one image, the phase difference calculator (e.g., the phase difference calculator 230) may identify an upper image based on the pixel data of the first pixel and the pixel data of the second pixel, and identify a lower image based on the pixel data of the third pixel and the pixel data of the fourth pixel. The phase difference calculator (e.g., the phase difference calculator 230) may calculate the test phase difference based on the disparity, which is the difference between a position of one spot in the upper image and a position of one spot in the lower image corresponding to the one spot in the upper image.

In one embodiment, the error calculator (e.g., the error calculator 240) of the image processing device 200 may calculate an error based on the difference between the calculated test phase difference and the lens position (S120). In one example, the error calculator (e.g., the error calculator 240) may calculate an error of the test phase difference based on the difference between the test phase difference calculated by the phase difference calculator (e.g., the phase difference calculator 230) and the lens position calculated by the lens controller 320. In one example, the error calculated by the error calculator (e.g., the error calculator 240) may correspond to a linearity error of the difference between the test phase difference and the lens position. For example, when the change in lens position (l) and the corresponding change in phase difference (d) have a linear relationship, a relation such as “d=α(al+b)” may hold (where, for example, “α” is a sensor-specific parameter, “a” is a first coefficient, and “b” is a second coefficient). In this case, the error calculator (e.g., the error calculator 240) may calculate the linearity error (e) as “|d−α(al+b)|”, representing the linearity error of the change in lens position (l) and the corresponding change in phase difference (d). For example, based on the equation “d=α(al+b)”, when “l” increases by 2, the ideal increase in “d” is α2a. Thus, the linearity error may correspond to the difference between the value of “d” measured when “l” increases by 2 and “d+α2a”.

In one embodiment, the weight determiner (e.g., the weight determiner 250) of the image processing device 200 may determine weights based on the calculated error (S130). In one example, the weight determiner (e.g., the weight determiner 250) may determine at least one weight corresponding to at least one pixel based on the error calculated by the error calculator (e.g., the error calculator 240). In one example, the weight determiner (e.g., the weight determiner 250) may determine a weight that may minimize the error calculated by the error calculator.

In one embodiment, the weight determiner (e.g., the weight determiner 250) may determine at least one weight corresponding to at least one region of the pixel array based on the error calculated by the error calculator (e.g., the error calculator 240). In one example, the weight determiner (e.g., the weight determiner 250) may divide the pixel array into multiple regions and determine a representative weight corresponding to each of the divided regions. For example, the image processing device 200 may divide the pixel array into N×M regions, calculate the test phase difference for each of the regions, and calculate an error corresponding to each region based on the difference between the calculated test phase difference for each of the regions and the lens position. Then, the weight determiner (e.g., the weight determiner 250) may determine a representative weight corresponding to each region based on the calculated error.

In one embodiment, the weight applicator (e.g., the weight applicator 220) of the image processing device 200 may apply the determined weights to the pixel data of the multiple pixels (S140). In one example, the weight applicator (e.g., the weight applicator 220) may apply the weights determined by the weight determiner (e.g., the weight determiner 250) to each individual pixel. For example, the weight applicator (e.g., the weight applicator 220) may apply a first weight to the pixel data of the first pixel, a second weight to the pixel data of the second pixel, a third weight to the pixel data of the third pixel, and a fourth weight to the pixel data of the fourth pixel.

In one embodiment, the weight determiner (e.g., the weight determiner 250) may divide the pixel array into multiple regions and determine a representative weight corresponding to each of the divided regions. Then, the weight applicator (e.g., the weight applicator 220) may apply the representative weight to the pixels included in each region. For example, the pixel data of the pixels included in one region of the pixel array may be collectively multiplied by the representative weight. For example, based on a first representative weight being determined by the weight determiner (e.g., the weight determiner 250) for a first region of the pixel array, the weight applicator (e.g., the weight applicator 220) may collectively multiply the data of the pixels included in the first region by the first representative weight. Also, based on a second representative weight being determined by the weight determiner (e.g., the weight determiner 250) for a second region of the pixel array, the weight applicator (e.g., the weight applicator 220) may collectively multiply the data of the pixels included in the second region by the second representative weight.

In one embodiment, the phase difference calculator (e.g., the phase difference calculator 230) of the image processing device 200 may calculate a corrected phase difference based on pixel data obtained by applying the weights to the pixel data of the multiple pixels (S150). In one example, the phase difference calculator (e.g., the phase difference calculator 230) may identify corrected pixel data obtained by applying the weights to the first to fourth pixels by the weight applicator 220 and extract a left-right phase difference image or an up-down phase difference image based on the identified corrected pixel data. In this case, the phase difference may correspond to the disparity of the left-right phase difference image or the up-down phase difference image. The phase difference calculator (e.g., the phase difference calculator 230) may calculate a corrected phase difference based on the extracted left-right or up-down phase difference image.

The image sensing device 10 may adjust the lens position using the lens controller (e.g., the lens controller 320), based on the corrected phase difference. In one example, the change in phase difference (e.g., test phase difference) calculated based on the pixel data before the application of weights may have a nonlinear relationship with the change in lens position. In this case, the image sensing device may have difficulty calculating the in-focus position of the lens according to a change in the distance to an object (e.g., the object 400) changes. On the other hand, when the lens position is adjusted based on the corrected phase difference, the change in phase difference and the change in lens position may have a linear relationship. Accordingly, the image sensing device 10 may more accurately calculate the in-focus position of the lens according to the change in the distance to the object (e.g., the object 400).

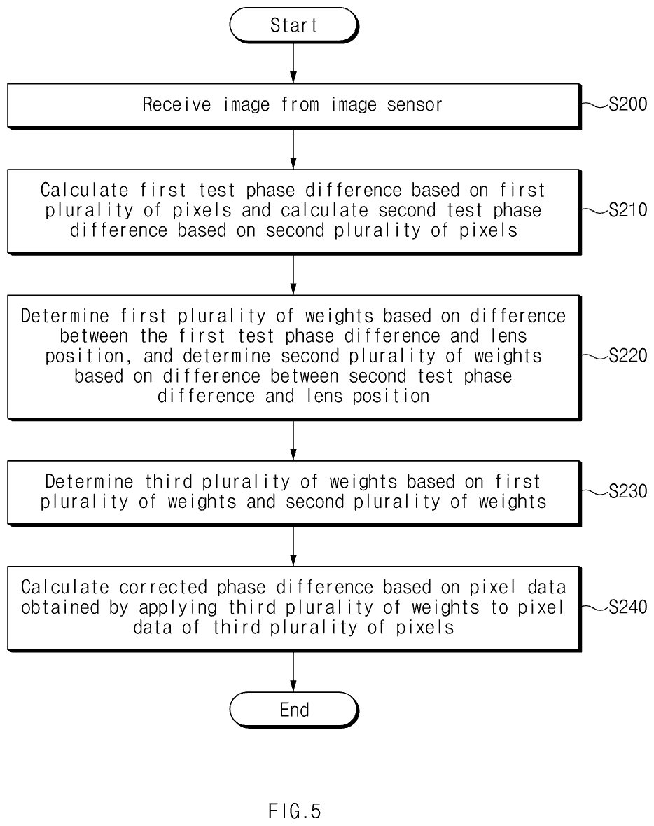

FIG. 5 is a flowchart illustrating the operation of an image processing device according to one embodiment of the disclosed technology.

Referring to FIG. 5, the image processing device 200 may receive an image from the image sensor 100 (S200). In one example, the image processing device 200 may receive image data (IDATA) from the image sensor 100. The image data (IDATA) may be mapped to correspond to coordinates of the pixel array. In one example, a unit pixel group may be positioned in at least one region of the pixel array. For example, a first pixel group including first to fourth pixels sharing a first microlens may be positioned in a first region of the pixel array. A second pixel group including fifth to eighth pixels sharing a second microlens may be positioned in a second region of the pixel array. A third pixel group including ninth to twelfth pixels sharing a third microlens may be positioned in a third region of the pixel array.

In one embodiment, the image data (IDATA) may include pixel data of pixels included in each pixel group corresponding to at least one region of the pixel array. For example, for the pixel group positioned in the first region of the pixel array, the image data (IDATA) may include pixel data of the first pixel, pixel data of the second pixel, pixel data of the third pixel, and pixel data of the fourth pixels. For the pixel group positioned in the second region of the pixel array, the image data (IDATA) may include pixel data of the fifth pixel, pixel data of the sixth pixel, pixel data of the seventh pixel, and pixel data of the eighth pixel. For the pixel group positioned in the third region of the pixel array, the image data (IDATA) may include pixel data of the ninth pixel, pixel data of the tenth pixel, pixel data of the eleventh pixel, and pixel data of the twelfth pixel. In one example, the first, fifth, and ninth pixels may be positioned in the first channel of the corresponding microlenses. The second, sixth, and tenth pixels may be positioned in the second channel of the corresponding microlenses. The third, seventh, and eleventh pixels may be positioned in the third channel of the corresponding microlenses. The fourth, eighth, and twelfth pixels may be positioned in the fourth channel of the corresponding microlenses.

In one embodiment, the image processing device 200 may identify phase information based on the multiple pixels included in the first to third pixel groups. For example, the first, fifth, and ninth pixels may be positioned in the first channel corresponding to the upper left side of the microlenses. The second, sixth, and tenth pixels may be positioned in the second channel corresponding to the upper right side of the microlenses. The third, seventh, and eleventh pixels may be positioned in the third channel corresponding to the lower left side of the microlenses. The fourth, eighth, and twelfth pixels may be positioned in the fourth channel corresponding to the lower right side of the microlenses. The image processing device 200 may calculate the phase difference based on a phase difference image generated by combining the pixel data of the first to twelfth pixels.

In one embodiment, the phase difference calculator (e.g., the phase difference calculator 230) of the image processing device 200 may calculate a first test phase difference based on a first plurality of pixels and calculate a second test phase difference based on a second plurality of pixels (S210). For example, the phase difference calculator (e.g., the phase difference calculator 230) may calculate the first test phase difference based on the pixel data of the first to fourth pixels, and the second test phase difference based on the pixel data of the fifth to eighth pixels. In one example, the phase difference calculator (e.g., the phase difference calculator 230) may extract a left-right or up-down image based on the pixel data of the first to eighth pixels. Then, the phase difference calculator (e.g., the phase difference calculator 230) may calculate the phase difference based on the disparity of the extracted left-right or up-down image.

For example, regarding one image, the phase difference calculator (e.g., the phase difference calculator 230) may identify a first upper image based on the pixel data of the first pixel and the pixel data of the second pixel, and identify a first lower image based on the pixel data of the third pixel and the pixel data of the fourth pixel. The phase difference calculator (e.g., the phase difference calculator 230) may calculate the first test phase difference based on the disparity, which is the difference between a position of one spot in the first upper image and a position of one spot in the first lower image corresponding to the one spot in the first upper image.

For example, regarding one image, the phase difference calculator (e.g., the phase difference calculator 230) may identify a second upper image based on the pixel data of the fifth pixel and the pixel data of the sixth pixel, and identify a second lower image based on the pixel data of the seventh pixel and the pixel data of the eighth pixel. The phase difference calculator (e.g., the phase difference calculator 230) may calculate the second test phase difference based on the disparity, which is the difference between a position of one spot in the second upper image and a position of one spot in the second lower image corresponding to the one spot in the second upper image.

In one embodiment, the weight determiner (e.g., the weight determiner 250) of the image processing device 200 may determine a first plurality of weights based on the difference between the first test phase difference and the lens position, and determine a second plurality of weights based on the difference between the second test phase difference and the lens position (S220). For example, the weight determiner (e.g., the weight determiner 250) may determine first to fourth weights based on the difference between the first test phase difference and the lens position, and fifth to eighth weights based on the difference between the second test phase difference and the lens position. The weight determiner (e.g., the weight determiner 250) may determine the first to fourth weights based on a first error calculated based on the difference between the first test phase difference and the lens position, and determine the fifth to eighth weights based on a second error calculated based on the difference between the second test phase difference and the lens position difference. The error calculator (e.g., the error calculator 240) may calculate both the first and second errors. For the operation of the error calculator (e.g., the error calculator 240), reference can be made to step S120 in FIG. 4 described above.

In one embodiment, the weight determiner (e.g., the weight determiner 250) may determine weights based on the calculated errors. For example, the weight determiner 250 may determine at least one weight corresponding to at least one pixel based on the errors calculated by the error calculator 240. The weight determiner 250 may determine weights that may minimize the errors calculated by the error calculator 240. For example, the weight determiner 250 may determine weights corresponding to each pixel included in the pixel array.

In one embodiment, the weight determiner (e.g., the weight determiner 250) may determine at least one weight corresponding to at least one region of the pixel array based on the error calculated by the error calculator (e.g., the error calculator 240). In one example, the weight determiner (e.g., the weight determiner 250) may divide the pixel array into multiple regions and determine a representative weight corresponding to each of the divided regions. For example, the image processing device 200 may divide the pixel array into N×M regions, calculate the test phase difference for each of the regions, and calculate an error corresponding to each region based on the difference between the calculated test phase difference for each of the regions and the lens position. Then, the weight determiner (e.g., the weight determiner 250) may determine a representative weight corresponding to each region based on the calculated error. For example, the weight determiner (e.g., the weight determiner 250) may determine a weight corresponding to each of the N×M regions of the pixel array. For example, a first weight corresponding to a first region may serve as the representative weight and correspond to all pixels included in the first region.

In one embodiment, the weight determiner (e.g., the weight determiner 250) may determine a third plurality of weights based on the first plurality of weights and the second plurality of weights (S230). In one example, the weight determiner (e.g., the weight determiner 250) may determine the ninth to twelfth weights based on the first to fourth weights and the fifth to eighth weights. For example, the weight determiner (e.g., the weight determiner 250) may determine the ninth weight as the average of the first and fifth weights, the tenth weight as the average of the second and sixth weights, the eleventh weight as the average of the third and seventh weights, and the twelfth weight as the average of the fourth and eighth weights.

In one embodiment, the weight determiner (e.g., the weight determiner 250) may determine ninth to twelfth weights by bilinearly interpolating the first to fourth weights and the fifth to eighth weights. For example, when the first weight applied to the first pixel positioned at (1, 0) is 1, and the fifth weight applied to the fifth pixel positioned at (4, 0) is 3, the ninth weight applied to the ninth pixel positioned at (2, 0) may correspond to 5/3.

In one embodiment, when the first, fifth, and ninth pixels have the same characteristic (e.g., the pixels are positioned in the upper left channel of the microlenses), the weight determiner (e.g., the weight determiner 250) may determine the ninth weight corresponding to the ninth pixel as a value obtained by bilinearly interpolating the first weight corresponding to the first pixel and the fifth weight corresponding to the fifth pixel. For example, when the second, sixth, and tenth pixels share have the same characteristic (e.g., the pixels are positioned in the upper right channel of the microlenses), the weight determiner (e.g., the weight determiner 250) may determine the tenth weight corresponding to the tenth pixel as a value obtained by bilinearly interpolating the second weight corresponding to the second pixel and the sixth weight corresponding to the sixth pixel. For example, when the third, seventh, and eleventh pixels have the same characteristic (e.g., the pixels are positioned in the lower left channel of the microlenses), the weight determiner (e.g., the weight determiner 250) may determine the eleventh weight corresponding to the eleventh pixel as a value obtained by bilinearly interpolating the third weight corresponding to the third pixel and the seventh weight corresponding to the seventh pixel. For example, when the fourth, eighth, and twelfth pixels have the same characteristic (e.g., the pixels are positioned in the lower right channel of the microlenses), the weight determiner (e.g., the weight determiner 250) may determine the twelfth weight corresponding to the twelfth pixel as a value obtained by bilinearly interpolating the fourth weight corresponding to the fourth pixel and the eighth weight corresponding to the eighth pixel.

In one embodiment, the phase difference calculator (e.g., the phase difference calculator 230) may calculate a corrected phase difference based on pixel data obtained by applying the third plurality of weights to the pixel data of the third plurality of pixels (S240). For example, the phase difference calculator (e.g., the phase difference calculator 230) may calculate a corrected phase difference based on pixel data obtained by applying the ninth to twelfth weights to the pixel data of the ninth to twelfth pixels. In one example, the weight applicator (e.g., the weight applicator 220) may apply the determined ninth to twelfth weights to the pixel data of the ninth to twelfth pixels. For the operation of the weight applicator (e.g., the weight applicator 220), reference can be made to step S140 in FIG. 4 described above.

In one embodiment, the phase difference calculator (e.g., the phase difference calculator 230) may identify corrected pixel data obtained by applying the weights to the ninth to twelfth pixels by the weight applicator (e.g., the weight applicator 220), and extract a left-right phase difference image or up-down phase difference image based on the identified corrected pixel data. Here, the phase difference may correspond to the disparity of the left-right or up-down phase difference image. The phase difference calculator (e.g., the phase difference calculator 230) may calculate the corrected phase difference based on the extracted left-right or up-down phase difference image.

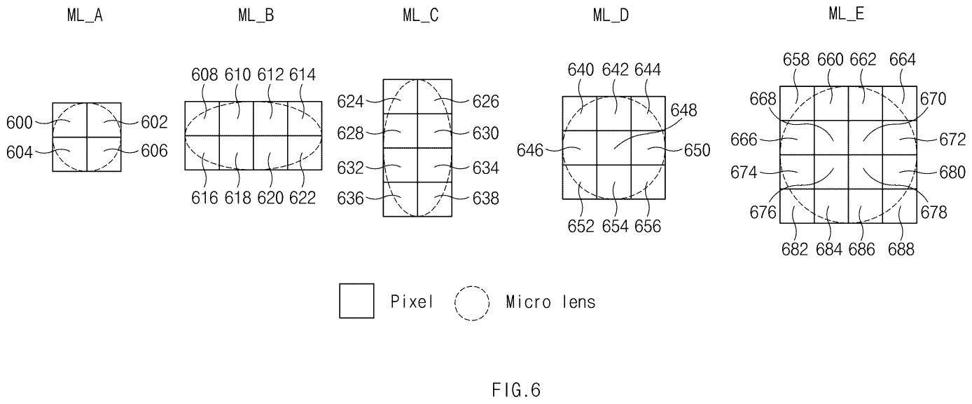

FIG. 6 is a diagram illustrating a microlens and multiple pixels corresponding thereto according to one embodiment of the disclosed technology.

Referring to FIG. 6, a microlens may correspond to an array of pixels arranged in multiple rows and multiple columns. In one example, the microlens may correspond to multiple types. For example, the microlens may correspond to a microlens type ML_A, which corresponds to a 2×2 array, a microlens type ML_B, which corresponds to a 2×4 array, a microlens type ML_C, which corresponds to a 4×2 array, a microlens type ML_D, which corresponds to a 3×3 array, and a microlens type ML_E, which corresponds to a 4×4 array.

In one embodiment, the microlens type ML_A corresponding to the 2×2 array may correspond to four channels. For example, a first pixel 600 may be positioned in a first channel corresponding to the upper left side of the microlens type ML_A. A second pixel 602 may be positioned in a second channel corresponding to the upper right side of the microlens type ML_A. A third pixel 604 may be positioned in a third channel corresponding to the lower left side of the microlens type ML_A. The fourth pixel 606) may be positioned in a fourth channel corresponding to the lower right side of the microlens type ML_A.

In one embodiment, the microlens type ML_A corresponding to the 2×2 array may correspond to four channels. For example, the four positions included in the microlens type ML_A corresponding to the 2×2 array may be represented as coordinates in two rows and two columns as follows. The first pixel 600 may be positioned in the first channel corresponding to a portion at the first row and first column of the microlens type ML_A. The second pixel 602 may be positioned in the second channel corresponding to a portion at the first row and second column of the microlens type ML_A. The third pixel 604 may be positioned in the third channel corresponding to a portion at the second row and first column of the microlens type ML_A. The fourth pixel 606 may be positioned in the fourth channel corresponding to a portion at the second row and second column of the microlens type ML_A.

In one embodiment, the microlens type ML_B corresponding to the 2×4 array may correspond to eight channels. For example, the eight positions included in the microlens type ML_B corresponding to the 2×4 array may be represented as coordinates in two rows and four columns as follows. A first pixel 608 may be positioned in the first channel corresponding to a portion at the first row and first column of the microlens type ML_B. A second pixel 610 may be positioned in the second channel corresponding to a portion at the first row and second column of the microlens type ML_B. A third pixel 612 may be positioned in the third channel corresponding to a portion at the first row and third column of the microlens type ML_B. A fourth pixel 614 may be positioned in the fourth channel corresponding to a portion at the first row and fourth column of the microlens type ML_B. A fifth pixel 616 may be positioned in the fifth channel corresponding to a portion at the second row and first column of the microlens type ML_B. A sixth pixel 618 may be positioned in the sixth channel corresponding to a portion at the second row and second column of the microlens type ML_B. A seventh pixel 620 may be positioned in the seventh channel corresponding to a portion at the second row and third column of the microlens type ML_B. An eighth pixel 622 may be positioned in the eighth channel corresponding to a portion at the second row and fourth column of the microlens type ML_B.

In one embodiment, the microlens type ML_C corresponding to the 4×2 array may correspond to eight channels. The microlens type ML_D corresponding to the 3×3 array may correspond to nine channels. The microlens type ML_E corresponding to the 4×4 array may correspond to sixteen channels. In one example, the channels of the microlens type ML_C corresponding to the 4×2 array, the microlens type ML_D corresponding to the 3×3 array, and the microlens type ML_E corresponding to the 4×4 array and the positions of the pixels corresponding thereto may be understood in a similar manner to the channels of the microlens type ML_A corresponding to the 2×2 array and the microlens type ML_B corresponding to the 2×4 array and the positions of the pixels corresponding thereto described above.

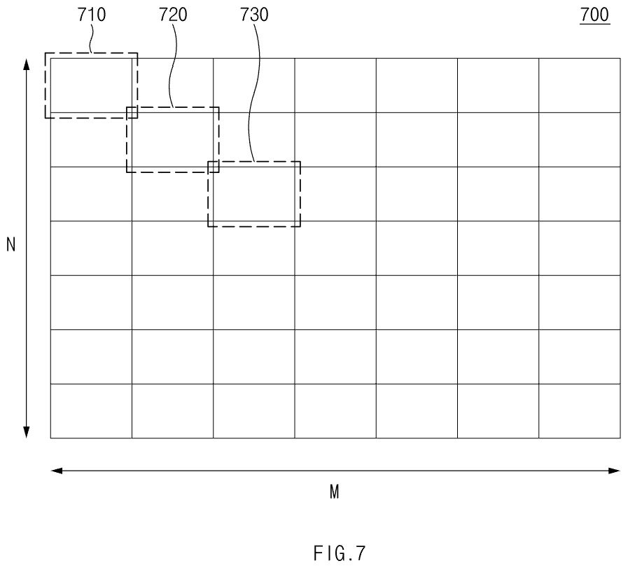

FIG. 7 is a diagram illustrating an example of step S230 shown in FIG. 5.

Referring to FIG. 7, the weight determiner (e.g., the weight determiner 250) of the image processing device 200 may determine a third plurality of weights based on the first plurality of weights and the second plurality of weights. For example, the weight determiner (e.g., the weight determiner 250) may determine the ninth to twelfth weights based on the first to fourth weights and the fifth to eighth weights. In one example, the weight determiner (e.g., the weight determiner 250) may determine the ninth to twelfth weights by bilinearly interpolating the first to fourth weights and the fifth to eighth weights. In one example, the first plurality of weights may be weights applied to the first plurality of pixels, and the second plurality of weights may be weights applied to the second plurality of pixels. The third plurality of weights may be applied to a third plurality of pixels.

In one embodiment, the weight determiner (e.g., the weight determiner 250) may divide the pixel array 700 into multiple regions and determine representative weights corresponding to the divided regions (e.g., regions 710, 720, and 730). For example, the image processing device 200 may divide the pixel array into N×M regions, calculate test phase differences in respective regions (e.g., regions 710 and 730), and calculate errors corresponding to the respective regions (e.g., regions 710 and 730) based on the difference between the test phase difference calculated in each of the regions (e.g., regions 710 and 730) and the lens position. In this case, the weight determiner (e.g., the weight determiner 250) may determine representative weights corresponding to the respective regions (e.g., regions 710 and 730) based on the calculated errors.

In one embodiment, the image processing device 200 may calculate a test phase difference based on the pixel data of the multiple pixels included in the first region 710 of the pixel array 700. For example, the image processing device 200 may calculate a first test phase difference based on the pixel data of the first to fourth pixels included in the first region 710, and calculate a first error based on the difference between the first test phase difference and the lens position. In this case, the weight determiner (e.g., the weight determiner 250) may determine first to fourth weights based on the calculated first error.

In one embodiment, the image processing device 200 may calculate a test phase difference based on the pixel data of the multiple pixels included in the second region 730 of the pixel array 700. For example, the image processing device 200 may calculate a second test phase difference based on the pixel data of the fifth to eighth pixels included in the second region 730, and calculate a second error based on the difference between the second test phase difference and the lens position. In this case, the weight determiner (e.g., the weight determiner 250) may determine fifth to eighth weights based on the calculated second error.

In one embodiment, the weight determiner (e.g., the weight determiner 250) of the image processing device 200 may determine ninth to twelfth weights applied to the ninth to twelfth pixels included in the third region 720 of the pixel array 700, based on the first to fourth weights and the fifth to eighth weights (S230). In one example, the weight determiner (e.g., the weight determiner 250) may determine ninth to twelfth weights by bilinearly interpolating the first to fourth weights and the fifth to eighth weights. For example, the ninth weight may correspond to the average of the first weight and the fifth weight, the tenth weight may correspond to the average of the second weight and the sixth weight, the eleventh weight may correspond to the average of the third weight and the seventh weight, and the twelfth weight may correspond to the average of the fourth weight and the eighth weight.

In one embodiment, the weight determiner (e.g., the weight determiner 250) of the image processing device 200 may determine a weight for a pixel group (e.g., a first pixel group including the first to fourth pixels or a second pixel group including the fifth to eighth pixels) based on pixel data of pixels included in the pixel group. For example, the weight determiner (e.g., the weight determiner 250) may divide the pixel array 700 into N×M regions and determine a weight for each region (e.g., the first region or the second region). In this case, the determined weight may be collectively applied to all pixels included in each region.

In one embodiment, the weight determiner (e.g., the weight determiner 250) of the image processing device 200 may determine a weight for a pixel group (e.g., the first pixel group including the first to fourth pixels or the second pixel group including the fifth to eighth pixels) based on the pixel data of the pixels included in the pixel group, and determine a weight for another pixel group (e.g., a third pixel group including the ninth to twelfth pixels) based on the determined weight. For example, the weight determiner (e.g., the weight determiner 250) may divide the pixel array 700 into N×M regions and determine a weight for each region (e.g., the first region 710 or the second region 730), and determine a weight for another region (e.g., the third region 720) based on the determined weight. In this case, the determined weight may be collectively applied to all pixels included in each region.

FIG. 8 is a diagram illustrating an operation of calculating a test phase difference according to one embodiment of the disclosed technology.

Referring to FIG. 8, the phase difference pixel extractor (e.g., the phase difference pixel extractor 210) of the image processing device 200 may extract pixels for calculation of a phase difference. In some implementations, the phase difference calculator (e.g., the phase difference calculator 230) may calculate a test phase difference based on a left-right phase difference image or an up-down phase difference image that is generated from the pixel data of the extracted pixels.

In one embodiment, the phase difference pixel extractor (e.g., the phase difference pixel extractor 210) may identify multiple pixels (e.g., pixels marked with dotted patterns in 800, 810, 820, and 830) sharing one microlens (e.g., a microlens of type ML_A). Then, the phase difference calculator (e.g., the phase difference calculator 230) may identify the pixel data of the multiple pixels (e.g., the pixels marked with dotted patterns in 800, 810, 820, and 830) corresponding to the current lens position of the image sensing device 10 or a preset lens position. In the example of the disclosed technology described with reference to FIG. 8, it is assumed that the pixel array (e.g., the pixel array 110) includes the microlens type ML_A corresponding to the 2×2 array.

In one embodiment, the phase difference calculator (e.g., the phase difference calculator 230) may identify a first pixel (corresponding to the dotted pattern 800), a second pixel (corresponding to the dotted pattern 810), a third pixel (corresponding to the dotted pattern 820), and a fourth pixel (corresponding to the dotted pattern 830) among multiple pixels sharing one microlens (the microlens of type ML_A). In one example, based on combinations of the first to fourth pixels, the phase difference calculator (e.g., the phase difference calculator 230) may identify a left pixel combination 840, a right pixel combination 850, a top pixel combination 870, or a bottom pixel combination 880.

In one embodiment, the phase difference calculator (e.g., the phase difference calculator 230) may identify the left pixel combination 840 by combining the first pixel (corresponding to the dotted pattern 800) and the third pixel (corresponding to the dotted pattern 820). In one example, the phase difference calculator (e.g., the phase difference calculator 230) may identify the right pixel combination 850 by combining the second pixel (corresponding to the dotted pattern 810) and the fourth pixel (corresponding to the dotted pattern 830). In one example, the phase difference calculator (e.g., the phase difference calculator 230) may identify the top pixel combination 870 by combining the first pixel (corresponding to the dotted pattern 800) and the second pixel (corresponding to the dotted pattern 810). In one example, the phase difference calculator (e.g., the phase difference calculator 230) may identify the bottom pixel combination 880 by combining the third pixel (corresponding to the dotted pattern 820) and the fourth pixel (corresponding to the dotted pattern 830).

In one embodiment, the phase difference calculator (e.g., the phase difference calculator 230) may generate a left image based on the left pixel combination 840 and generate a right image based on the right pixel combination 850. In one example, for other pixels included in the pixel array (e.g., the pixel array 110), the image processing device 200 may identify a left pixel combination or right pixel combination in a similar manner to that described above. The image processing device 200 may generate a left image based on the identified left pixel combinations and generate a right image based on the identified right pixel combinations.

In one embodiment, the phase difference calculator (e.g., the phase difference calculator 230) may calculate the phase difference of the left image generated based on the left pixel combination 840 and the right image generated based on the right pixel combination 850 using a Sum of Absolute Difference (SAD) method 860 to calculate a test phase difference (T_D1). While it is described in the example of FIG. 8 that the phase difference is calculated using the SAD method, the method of calculating the phase difference is not limited to the SAD method. For example, the phase difference calculator (e.g., the phase difference calculator 230) may calculate the phase difference of the left image and the right image using a Sum of Squared Difference (SSD) method.

In one embodiment, the test phase difference (T_D1) of the left image and the right image may be calculated using Equations 10 and 11. In Equations 10 and 11, I₁ may correspond to the left image, I₂ may correspond to the right image, (x, y) may correspond to reference coordinates commonly corresponding to I₁ and I₂, I₁(x, y) may correspond to pixel data of a pixel positioned at (x, y) in I₁, I₂(x, y) may correspond to pixel data of a pixel positioned at (x, y) in I₂, X, −X, Y, and −Y may correspond to parameters corresponding to a preset SAD search range, (sₓ, s_{y}) may correspond to reference coordinates for SAD search, d′ₓ may correspond to sₓ to which the argmin function is applied, and d′_{y} may correspond to s_{y} to which the argmin function is applied. In one example, argmin ({SAD}) may be a function that derives the minimum result value of SAD(sₓ, s_{y}). In one example, Disparity(d′ₓ, d′_{y}) may correspond to parameters corresponding to the x and y components of the test phase difference (T_D1).

$$SAD ( {s}_{x} , {s}_{y} ) = {\sum }_{{s}_{x} = - X}^{X} {\sum }_{{s}_{y = - Y}}^{Y} \vert {I}_{1} ( {s}_{x} + x , {s}_{y} + y ) - {I}_{2} ( x , y ) \vert \qquad [ Equation 10 ]$$

$$Disparity ( {d}_{x}^{′} , {d}_{y}^{′} ) = arg min ( \{ SAD \} ) \qquad [ Equation 11 ]$$

For example, when the left image generated based on the left pixel combination 840 and the right image generated based on the right pixel combination 850 have a left-right phase difference corresponding to a distance of 2 pixels, the phase difference calculator (e.g., the phase difference calculator 230) may calculate, for the SAD search range corresponding to X, −X, Y, and −Y, |I₁(2+x, 0+y)−I₂(x, y)|=0. Since |I₁(sₓ+X, s_{y}+y)−I₂(x, y)| reaches the minimum value when it is equal to 0, the phase difference calculator (e.g., the phase difference calculator 230) may identify sₓ=2 and s_{y}=0 using the argmin function. Accordingly, the phase difference calculator (e.g., the phase difference calculator 230) may identify Disparity(2,0), and calculate the left-right phase difference as a distance of 2 pixels.

In one embodiment, the phase difference calculator (e.g., the phase difference calculator 230) may generate a top image based on the top pixel combination 870 and generate a bottom image based on the bottom pixel combination 880. In one example, the image processing device 200 may identify the top pixel combination or bottom pixel combination for other pixels included in the pixel array (e.g., the pixel array 110) in a similar manner to that described above. The image processing device 200 may generate the top image based on the identified top pixel combinations and generate the bottom image based on the identified bottom pixel combinations.

In one embodiment, the phase difference calculator (e.g., the phase difference calculator 230) may calculate the phase difference of the top image generated based on the top pixel combination 870 and the bottom image generated based on the bottom pixel combination 880 using a SAD method 890 to calculate a test phase difference (T_D2). While it is described in the example of FIG. 8 that the phase difference is calculated using the SAD method, the method of calculating the phase difference is not limited to the SAD method. For example, the phase difference calculator (e.g., the phase difference calculator 230) may calculate the phase difference of the top image and the bottom image using the SSD method.

In one embodiment, the test phase difference (T_D2) of the top image and the bottom image may be calculated using Equations 10 and 11 above. In Equations 10 and 11, I₁ may correspond to the top image, and I₂ may correspond to the bottom image. Since Equations 10 and 11 and the definitions of the parameters used in the equations have been described above, description of common details will be skipped.

For example, when the top image generated based on the top pixel combination 870 and the bottom image generated based on the bottom pixel combination 880 have an up-down phase difference corresponding to a distance of 5 pixels, the phase difference calculator (e.g., the phase difference calculator 230) may calculate, for the SAD search range corresponding to X, −X, Y, and −Y, |I₁(0+x, −5+y)−I₂(x, y)|=0. Since |₁(sₓ+X, s_{y}+y)−I₂(x, y)| reaches the minimum value when it is equal to 0, the phase difference calculator (e.g., the phase difference calculator 230) may identify sₓ=0 and s_{y}=−5 using the argmin function. Accordingly, the phase difference calculator (e.g., the phase difference calculator 230) may identify Disparity (0, −5), and calculate the up-down phase difference as a distance of 5 pixels.

FIG. 9 is a diagram illustrating an optical path of light incident on a pixel and a lens position.

FIG. 9 illustrates the path of incident light originating from an object 400, passing through the lens 310, and incident on a first microlens ML1 according to one embodiment of the disclosed technology. The example as shown in FIG. 9 which illustrates the first microlens ML1, color filter CF, and photoelectric conversion device PD corresponds to a configuration in which multiple pixels share one microlens. For example, each pixel of a pixel array (e.g., the pixel array 110) may include one photoelectric conversion device PD. Multiple pixels may share the first microlens ML1, and the color filter CF may be disposed between the pixels and the first microlens ML1. FIG. 9 is merely a schematic diagram provided for ease of understanding, and the ratio between the lens 310 and the first microlens ML1 shown in the figure is not necessarily equal to the actual ratio between the lens 310 and the first microlens ML1. In one example, referring to FIGS. 6 and 9, the first microlens ML1 may correspond to the microlens type ML_A corresponding to the 2×2 array.

In one embodiment, L1 to L4 respectively represent the paths of incident light, and F indicates the focal point of the lens 310. For example, incident light originating from the object 400 and incident along L1 to L4 with respect to the optical axis may be guided by the first microlens ML1 to the photoelectric conversion device PD. In one example, as the amount of incident light reaching the photoelectric conversion device PD or photoelectric conversion region through the first microlens ML1 decreases, the sensitivity of the pixels may be adjusted.

In one embodiment, L may correspond to the distance between the image sensor (e.g., the image sensor 100) and the lens (e.g., the lens 310). For example, referring to FIGS. 1 and 9, the image processing device 200 may calculate the phase difference to adjust L to make the distance between the lens 310 and the object 400 correspond to the in-focus position. For example, the image processing device 200 may calculate the phase difference based on a phase difference signal and adjust the lens position such that the calculated phase difference is eliminated. In one example, the phase difference may vary according to L.

In one embodiment, when the distance between the image sensor 100 and the lens is L, incident light originating from the object 400 may reach pixels included in the image sensor 100, and there may be a phase difference between signals generated by the pixels included in the image sensor 100. In this case, the image processing device 200 may calculate L′ at which the phase difference of the signals generated by the pixels included in the image sensor 100 is eliminated. For example, the image processing device 200 may control the lens controller 320 to adjust the lens position such that L is equal to L′.

In one embodiment, the image processing device 200 may use “L” as a value corresponding to the lens position to compare the phase difference and the lens position and calculate an error of the phase difference. In one example, referring to FIG. 9, “L” may correspond to “l” in Equation 1 for error calculation. For example, Equation 1 may correspond to e=|d−α(aL+b)|.

FIG. 10A is a diagram illustrating an operation of calculating a corrected phase difference according to one embodiment of the disclosed technology.

Referring to FIG. 10A, the weight applicator (e.g., the weight applicator 220) of the image processing device 200 may apply weights determined by the weight determiner (e.g., the weight determiner 250) to pixel data of pixels for calculation of a phase difference. Also, the phase difference calculator (e.g., the phase difference calculator 230) may calculate a corrected phase difference based on a left-right phase difference image or up-down phase difference image generated from pixel data obtained by applying the weights to the pixel data of the pixels.

In one embodiment, the weight applicator (e.g., the weight applicator 220) may apply weights (e.g., W_L1, W_R1, W_L2, and W_R2) to multiple pixels (e.g., the pixels marked with dotted patterns in 800, 810, 820, and 830) sharing one microlens. Then, the phase difference calculator (e.g., the phase difference calculator 230) may identify pixel data obtained by applying the weights to the pixel data of the multiple pixels (e.g., the pixels marked with dotted patterns in 800, 810, 820, and 830) according to the current lens position of the image sensing device 10 or a preset lens position. In the example described with reference to FIG. 10A, it is assumed that the pixel array (e.g., the pixel array 110) includes the microlens type ML_A corresponding to the 2×2 array.

In one embodiment, the phase difference calculator (e.g., the phase difference calculator 230) may identify, among the multiple pixels sharing one microlens (e.g., a microlens of type ML_A) and having weights (e.g., W_L1, W_R1, W_L2, and W_R2) applied thereto, a first pixel (corresponding to the diagonal pattern in 1000) to which W_L1 is applied, a second pixel (corresponding to the diagonal pattern in 1002) to which W_R1 is applied, a third pixel (corresponding to the diagonal pattern in 1004) to which W_L2 is applied, and a fourth pixel (corresponding to the diagonal pattern in 1006) to which W_R2 is applied. In one example, based on pixel combinations of the first to fourth pixels to which the weights (e.g., W_L1, W_R1, W_L2, and W_R2) are applied, the phase difference calculator (e.g., the phase difference calculator 230) may identify a weighted left pixel combination 1008, a weighted right pixel combination 1010, a weighted top pixel combination 1014, or a weighted bottom pixel combination 1016.

In one embodiment, the phase difference calculator (e.g., the phase difference calculator 230) may identify the weighted left pixel combination 1008 by combining the first pixel (corresponding to the diagonal pattern in 1000) to which W_L1 is applied and the third pixel (corresponding to the diagonal pattern in 1004) to which W_L2 is applied. In one example, the phase difference calculator (e.g., the phase difference calculator 230) may identify the weighted right pixel combination 1010 by combining the second pixel (corresponding to the diagonal pattern in 1002) to which W_R1 is applied and the fourth pixel (corresponding to the diagonal pattern in 1006) to which W_R2 is applied. In one example, the phase difference calculator (e.g., the phase difference calculator 230) may identify the weighted top pixel combination 1014 by combining the first pixel (corresponding to the diagonal pattern in 1000) to which W_L1 is applied and the second pixel (corresponding to the diagonal pattern in 1002) to which W_R1 is applied. In one example, the phase difference calculator (e.g., the phase difference calculator 230) may identify the weighted bottom pixel combination 1016 by combining the third pixel (corresponding to the diagonal pattern in 1004) to which W_L2 is applied and the fourth pixel (corresponding to the diagonal pattern in 1006) to which W_R2 is applied.

In one embodiment, the phase difference calculator (e.g., the phase difference calculator 230) may generate a corrected left image based on the weighted left pixel combination 1008 and generate a corrected right image based on the weighted right pixel combination 1010. In one example, for weighted pixel data of the other pixels included in the pixel array (e.g., the pixel array 110), the image processing device 200 may identify a weighted left pixel combination or weighted right pixel combination in the same manner as described above. The image processing device 200 may generate a corrected left image based on the identified left pixel combinations and generate a corrected right image based on the identified right pixel combinations.

In one embodiment, the phase difference calculator (e.g., the phase difference calculator 230) may calculate the phase difference of the corrected left image generated based on the weighted left pixel combination 1008 and the corrected right image generated based on the weighted right pixel combination 1010 using a SAD method 1012 to calculate a corrected left-right phase difference (C_D1). While it is described in the example of FIG. 10A that the phase difference is calculated using the SAD method, the method of calculating the phase difference is not limited to the SAD method. For example, the phase difference calculator (e.g., the phase difference calculator 230) may calculate the phase difference of the left image and the right image using the SSD method.

In one embodiment, the corrected left-right phase difference (C_D1) of the corrected left image and the corrected right image may be calculated using Equations 10 and 11 above. In Equations 10 and 11, I₁ may correspond to the corrected left image, and I₂ may correspond to the corrected right image. Since Equations 10 and 11 and the definitions of the parameters used in the equations have been described above, description of common details will be skipped.

For example, when the corrected left image generated based on the weighted left pixel combination 1008 and the corrected right image generated based on the weighted right pixel combination 1010 have a left-right phase difference corresponding to a distance of 1 pixel, the phase difference calculator (e.g., the phase difference calculator 230) may calculate, for the SAD search range corresponding to X, −X, Y, and −Y, |I₁(1+x, 0+y)−I₂(x, y)|=0. Since |I₁(sₓ+X, s_{y}+y)−I₂(x, y)| reaches the minimum value when it is equal to 0, the phase difference calculator (e.g., the phase difference calculator 230) may identify sₓ=1 and s_{y}=0 using the argmin function. Accordingly, the phase difference calculator (e.g., the phase difference calculator 230) may identify Disparity(1,0), and calculate the corrected left-right phase difference as a distance of 1 pixel. In one example, referring to FIGS. 8 and 10A, the weighted left pixel combination 1008 may correspond to a pixel combination obtained by applying the weights to the left pixel combination 840, and the weighted right pixel combination 1010 may correspond to a pixel combination obtained by applying the weights to the right pixel combination 850.

In one embodiment, the phase difference calculator (e.g., the phase difference calculator 230) may generate a corrected top image based on the weighted top pixel combination 1014 and generate a corrected bottom image based on the weighted bottom pixel combination 1016. In one example, for weighted pixel data of the other pixels included in the pixel array (e.g., the pixel array 110), the image processing device 200 may identify a weighted top pixel combination or weighted bottom pixel combination in the same manner as described above. The image processing device 200 may generate a corrected top image based on the identified top pixel combinations and generate a corrected bottom image based on the identified bottom pixel combinations.

In one embodiment, the phase difference calculator (e.g., the phase difference calculator 230) may calculate the phase difference of the corrected top image generated based on the weighted top pixel combination 1014 and the corrected bottom image generated based on the weighted bottom pixel combination 1016 using a SAD method 1018 to calculate a corrected up-down phase difference (C_D2). While it is described in the example of FIG. 10A that the phase difference is calculated using the SAD method, the method of calculating the phase difference is not limited to the SAD method. For example, the phase difference calculator (e.g., the phase difference calculator 230) may calculate the phase difference of the top image and the bottom image using the SSD method.

In one embodiment, the corrected up-down phase difference (C_D2) of the corrected top image and the corrected bottom image may be calculated using Equations 10 and 11 above. In Equations 10 and 11, I₁ may correspond to the corrected top image, and I₂ may correspond to the corrected bottom image. Since Equations 10 and 11 and the definitions of the parameters used in the equations have been described above, description of common details will be skipped.

For example, when the corrected top image generated based on the weighted top pixel combination 1014 and the corrected bottom image generated based on the weighted bottom pixel combination 1016 have an up-down phase difference corresponding to a distance of 0 pixel, the phase difference calculator (e.g., the phase difference calculator 230) may calculate, for the SAD search range corresponding to X, −X, Y, and −Y, |I₁(0+x, 0+y)−I₂(x, y)|=0. Since |₁(sₓ+X, s_{y}+y)−I₂(x, y)| reaches the minimum value when it is equal to 0, the phase difference calculator (e.g., the phase difference calculator 230) may identify sₓ=0 and s_{y}=0 using the argmin function. Accordingly, the phase difference calculator (e.g., the phase difference calculator 230) may identify Disparity (0,0), and calculate the corrected up-down phase difference as 0. In this case, the position of the lens (e.g., the lens 310) of the image sensing device 10 may be an in-focus position. In one example, referring to FIGS. 8 and 10A, the weighted top pixel combination 1014 may correspond to a pixel combination obtained by applying the weights to the top pixel combination 870, and the weighted bottom pixel combination 1016 may correspond to a pixel combination obtained by applying the weights to the bottom pixel combination 880.

FIG. 10B is a diagram illustrating an operation of calculating a corrected phase difference according to a microlens type ML_D corresponding to a 3×3 array according to one embodiment of the disclosed technology.

Referring to FIG. 10B, the phase difference pixel extractor (e.g., the phase difference pixel extractor 210) of the image processing device 200 may identify multiple pixels sharing one microlens (e.g., a microlens of type ML_D). In this case, the phase difference calculator (e.g., the phase difference calculator 230) may identify pixel data (e.g., I₀₀, I₀₁, I₀₂, I₁₀, I₁₁, I₁₂, I₂₀, I₂₁, and I₂₂) of the multiple pixels according to the current lens position of the image sensing device 10 or a preset lens position. In the example described with reference to FIG. 10B, it is assumed that the pixel array (e.g., the pixel array 110) includes the microlens type ML_D corresponding to the 3×3 array.

In one embodiment, the phase difference calculator (e.g., the phase difference calculator 230) may identify a weighted left pixel combination 1068 by applying W_{L1} to the pixel data I₀₀ of a first pixel, W_{L2} to the pixel data I₁₀ of a fourth pixel, W_{L3} to the pixel data I₂₀ of a seventh pixel, W_{CL1} to the pixel data I₀₁ of a second pixel, W_{CL2} to the pixel data I₁₁ of a fifth pixel, and W_{CL3} to the pixel data I₂₁ of an eighth pixel among the multiple pixels sharing one microlens (e.g., a microlens of type ML_D).

In one embodiment, the phase difference calculator (e.g., the phase difference calculator 230) may identify a weighted right pixel combination 1070 by applying W_{CR1} to the pixel data lot of the second pixel, W_{CR2} to the pixel data I₁₁ of the fifth pixel, W_{CR3} to the pixel data I₂₁ of the eighth pixel, W_{R1} to the pixel data I₀₂ of the third pixel, W_{R2} to the pixel data I₁₂ of the sixth pixel, and W_{R3} to the pixel data I₂₂ of the ninth pixel among the multiple pixels sharing one microlens (e.g., a microlens of type ML_D).

In one embodiment, the phase difference calculator (e.g., the phase difference calculator 230) may generate a corrected left image based on the weighted left pixel combination 1068 and generate a corrected right image based on the weighted right pixel combination 1070. In one example, for weighted pixel data of the other pixels included in the pixel array (e.g., the pixel array 110), the image processing device 200 may identify a weighted left pixel combination or weighted right pixel combination in the same manner as described above. The image processing device 200 may generate a corrected left image based on the identified left pixel combinations and generate a corrected right image based on the identified right pixel combinations.

In one embodiment, the phase difference calculator (e.g., the phase difference calculator 230) may calculate the phase difference of the corrected left image generated based on the weighted left pixel combination 1068 and the corrected right image generated based on the weighted right pixel combination 1070 using a SAD method 1072 to calculate a corrected left-right phase difference (C_D1). While it is described in the example of FIG. 10B that the phase difference is calculated using the SAD method, the method of calculating the phase difference is not limited to the SAD method. For example, the phase difference calculator (e.g., the phase difference calculator 230) may calculate the phase difference of the left image and the right image using the SSD method.

In one embodiment, the corrected left-right phase difference (C_D1) of the corrected left image and the corrected right image may be calculated using Equations 10 and 11 above. In Equations 10 and 11, I₁ may correspond to the corrected left image, and I₂ may correspond to the corrected right image. Since Equations 10 and 11 and the definitions of the parameters used in the equations have been described above, description of common details will be skipped.

For example, when the corrected left image generated based on the weighted left pixel combination 1068 and the corrected right image generated based on the weighted right pixel combination 1070 have a left-right phase difference corresponding to a distance of 1 pixel, the phase difference calculator (e.g., the phase difference calculator 230) may calculate, for the SAD search range corresponding to X, −X, Y, and −Y, |I₁(2+x, 0+y)−I₂(x, y)|=0. Since |I₁(sₓ+x, s_{y}+y)−I₂(x, y)| reaches the minimum value when it is equal to 0, the phase difference calculator (e.g., the phase difference calculator 230) may identify sₓ=2 and s_{y}=0 using the argmin function. Accordingly, the phase difference calculator (e.g., the phase difference calculator 230) may identify Disparity (2,0), and calculate the corrected left-right phase difference as a distance of 2 pixels.

In one embodiment, the phase difference calculator (e.g., the phase difference calculator 230) may identify a weighted top pixel combination 1074 by applying W_{T1} to the pixel data I₀₀ of the first pixel, W_{T2} to the pixel data lot of the second pixel, W_{T3} to the pixel data I₀₂ of the third pixel, W_{CT1} to the pixel data I₁₀ of the fourth pixel, W_{CT2} to the pixel data I₁₁ of the fifth pixel, and W_{CT3} to the pixel data I₁₂ of the sixth pixel among the multiple pixels sharing one microlens (e.g., a microlens of type ML_D).

In one embodiment, the phase difference calculator (e.g., the phase difference calculator 230) may identify a weighted bottom pixel combination 1076 by applying W_{CB1} to the pixel data I₁₀ of the fourth pixel, W_{CB2} to the pixel data I₁₁ of the fifth pixel, W_{CB3} to the pixel data I₁₂ of the sixth pixel, W_{B1} to the pixel data I₂₀ of the seventh pixel, W_{B2} to the pixel data I₂₁ of the eighth pixel, and W_{B3} to the pixel data I₂₂ of the ninth pixel among the multiple pixels sharing one microlens (e.g., a microlens of type ML_D).

In one embodiment, the phase difference calculator (e.g., the phase difference calculator 230) may generate a corrected top image based on the weighted top pixel combination 1074 and generate a corrected bottom image based on the weighted bottom pixel combination 1076. In one example, for weighted pixel data of the other pixels included in the pixel array (e.g., the pixel array 110), the image processing device 200 may identify a weighted top pixel combination or weighted bottom pixel combination in the same manner as described above. The image processing device 200 may generate a corrected top image based on the identified top pixel combinations and generate a corrected bottom image based on the identified bottom pixel combinations.

In one embodiment, the phase difference calculator (e.g., the phase difference calculator 230) may calculate the phase difference of the corrected top image generated based on the weighted top pixel combination 1074 and the corrected bottom image generated based on the weighted bottom pixel combination 1076 using a SAD method 1078 to calculate a corrected up-down phase difference (C_D2). While it is described in the example of FIG. 10B that the phase difference is calculated using the SAD method, the method of calculating the phase difference is not limited to the SAD method. For example, the phase difference calculator (e.g., the phase difference calculator 230) may calculate the phase difference of the top image and the bottom image using the SSD method.

In one embodiment, the corrected up-down phase difference (C_D2) of the corrected top image and the corrected bottom image may be calculated using Equations 10 and 11 above. In Equations 10 and 11, I₁ may correspond to the corrected top image, and I₂ may correspond to the corrected bottom image. Since Equations 10 and 11 and the definitions of the parameters used in the equations have been described above, description of common details will be skipped.

For example, when the corrected top image generated based on the weighted top pixel combination 1074 and the corrected bottom image generated based on the weighted bottom pixel combination 1076 have an up-down phase difference corresponding to a distance of 10 pixels, the phase difference calculator (e.g., the phase difference calculator 230) may calculate, for the SAD search range corresponding to X, −X, Y, and −Y, |I₁(0+x, −10+y)−I₂(x, y)|=0. Since |I₁(sₓ+X, s_{y}+y)−I₂(x, y)| reaches the minimum value when it is equal to 0, the phase difference calculator (e.g., the phase difference calculator 230) may identify sₓ=0 and s_{y}=0 using the argmin function. Accordingly, the phase difference calculator (e.g., the phase difference calculator 230) may identify Disparity (0, −10), and calculate the up-down phase difference as a distance of 5 pixels.

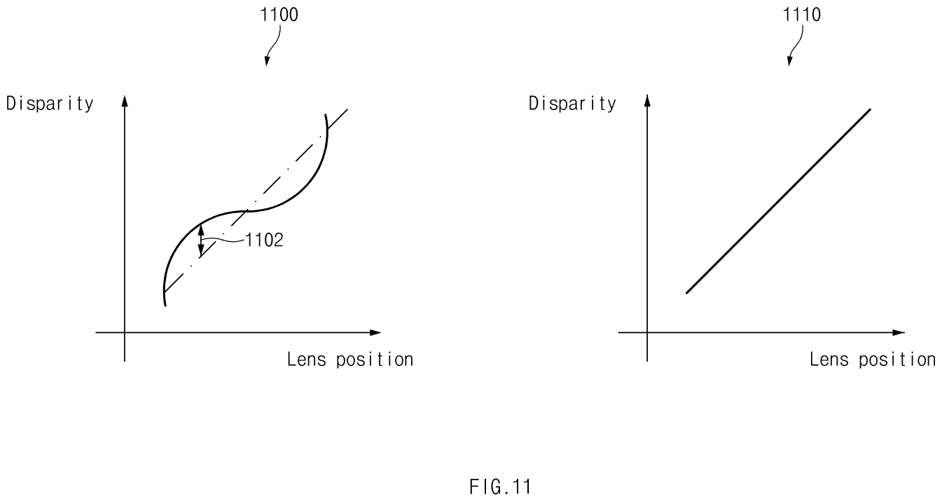

FIG. 11 is a graph depicting a linearity relationship between the phase difference and the lens position according to one embodiment of the disclosed technology.

Referring to FIG. 11, the graph of the change of the phase difference according to the lens position may include a graph 1100 of the change of the test phase difference (e.g., T_D1 or T_D2 of FIG. 8) according to the lens position and a graph 1110 of the change of the corrected phase difference (e.g., C_D1 or C_D2 of FIG. 10A) according to the lens position. In one example, referring to the graph 1100 of the change of the test phase difference (e.g., T_D1 or T_D2 of FIG. 8) according to the lens position, the change of the test phase difference and the change of the lens position may correspond to a nonlinear relationship. In one example, referring to the graph 1110 of the change of the corrected phase difference (e.g., C_D1 or C_D2 of FIG. 10A) according to the lens position, the change of the corrected phase difference and the change of the lens position may be close to a linear relationship.

In one embodiment, referring to the graph 1100 of the change of the test phase difference (e.g., T_D1 or T_D2 of FIG. 8) according to the lens position, a linearity error 1102 occurring in the calculation operation of the phase difference calculator (e.g., the phase difference calculator 230) may be confirmed. The image processing device 200 may adjust the lens position according to the phase difference using the lens controller (e.g., the lens controller 320), assuming that the change of the lens position and the change of the uncorrected phase difference (e.g., T_D1 or T_D2 of FIG. 8) have a linear relationship. In this case, due to the characteristics of the image sensor 100, the curvature of the lens, and the like, the linearity error 1102 may occur between the change of the lens position and the change of the uncorrected phase difference (e.g., T_D1 or T_D2 of FIG. 8). For example, when the phase difference calculator (e.g., the phase difference calculator 230) of the image processing device 200 acquires phase difference information based on the uncorrected phase difference, the result of calculation of the in-focus position of the lens by the phase difference calculator (e.g., the phase difference calculator 230) based on the phase difference may have an error because the change of the lens position and the change of the uncorrected phase difference (e.g., T_D1 or T_D2 of FIG. 8) have a nonlinear relationship.

In one embodiment, the image processing device 200 may more accurately calculate the change of the lens position according to the change of the phase difference based on the graph 1110 of the change of the corrected phase difference (e.g., C_D1 or C_D2 of FIG. 10A). For example, when the phase difference calculator (e.g., the phase difference calculator 230) of the image processing device 200 acquires phase difference information based on the corrected phase difference, the error in the calculation result of the in-focus position of the lens by the phase difference calculator (e.g., the phase difference calculator 230) based on the phase difference may be reduced because the relationship between the change of the lens position and the change of the corrected phase difference (e.g., C_D1 or C_D2 of FIG. 10a) is close to a linear relationship.

FIG. 12 is a diagram illustrating the phase difference of an image according to one embodiment of the disclosed technology.

Referring to FIG. 12, the image data (IDATA) may include images generated by pixels included in the respective channels. In one example, there may be phase differences between the images generated by the pixels included in the respective channels. In the example described with reference to FIG. 12, it is assumed that the pixel array (e.g., the pixel array 110) includes the microlens type ML_A corresponding to the 2×2 array.

For example, a pixel corresponding to the upper left side of the microlens may be positioned in a first channel, a pixel corresponding to the upper right side of the microlens may be positioned in a second channel, a pixel corresponding to the lower left side of the microlens may be positioned in a third channel, and a pixel corresponding to the lower right side of the microlens may be positioned in a fourth channel. The image processing device 200 may calculate the phase difference based on a phase difference image generated by combining the pixel data of the pixels positioned in the first to fourth channels.

In one embodiment, the image processing device 200 may generate a left image based on the pixel data of the pixels positioned in the first and third channels, and generate a right image based on the pixel data of the pixels positioned in the second and fourth channels. For example, when the coordinates of the center of a reference kernel 1210 of the pixel array is set to (0, 0), the phase difference calculated based on the generated left and right images may correspond to a distance of x pixels. In this case, the coordinates of the center of a left-right phase difference kernel 1220 corresponding to the reference kernel 1210 may correspond to (x, 0).

In one embodiment, the image processing device 200 may generate a top image based on the pixel data of the pixels positioned in the first and second channels, and generate a bottom image based on the pixel data of the pixels positioned in the third and fourth channels. For example, when the coordinates of the center of the reference kernel 1210 of the pixel array is set to (0, 0), the phase difference calculated based on the generated top and bottom images may correspond to a distance of y pixels. In this case, the coordinates of the center of an up-down phase difference kernel 1230 corresponding to the reference kernel 1210 may correspond to (0, y).

In one embodiment, the images generated based on the pixel data of the pixels positioned in the first through fourth channels may include both left-right and up-down phase differences. For example, when the coordinates of the center of the reference kernel 1210 of the pixel array is set to (0, 0), the phase difference of the images generated based on the pixel data of the pixels positioned in the first through fourth channels may correspond to a distance of r pixels. In this case, the coordinates the center of a phase difference kernel 1240 corresponding to the reference kernel 1210 may correspond to (x, y).

In one embodiment, the image processing device 200 may adjust the position of the lens (e.g., the lens 310) using the lens controller (e.g., the lens controller 320) to reduce the phase difference of the images generated based on the pixel data of the pixels positioned in the first through fourth channels. For example, the image processing device 200 may adjust the position of the lens (e.g., the lens 310) using the lens controller (e.g., the lens controller 320) such that the phase difference kernel 1240 coincides with the reference kernel 1210. When the phase difference kernel 1240 and the reference kernel 1210 coincide, the position of the lens may correspond to the in-focus position.

In one embodiment, the image processing device 200 may determine weights for phase difference correction based on the relationship between the phase difference kernel 1240 and the reference kernel 1210. In one example, the weight applicator (e.g., the weight applicator 220) may determine the weights according to Equations 2 to 9 above. In Equations 2 to 5, W_{L1} may correspond to a first weight, W_{R1} to a second weight, W_{L2} to a third weight, W_{R2} to a fourth weight, a₁ to a first weight coefficient, a₂ to a second weight coefficient, I₀₀ to a first pixel, I₁₀ to a second pixel, I₀₁ to a third pixel, I₁₁ to a fourth pixel, I(L) to a left image, and I(R) to a right image. In Equations 6 to 9, W_{T1} may correspond to a first weight, W_{B1} to a second weight, W_{T2} to a third weight, W_{B2} to a fourth weight, a₁ to a first weight coefficient, a₂ to a second weight coefficient, I₀₀ to a first pixel, I₁₀ to a second pixel, I₀₁ to a third pixel, I₁₁ to a fourth pixel, I(T) to a top image, and I(B) to a bottom image.

In one embodiment, the image processing device 200 may determine the first weight coefficient (e.g., a₁) or the second weight coefficient (e.g., a₂) based on the relationship between the phase difference kernel 1240 and the reference kernel 1210. The image processing device 200 may determine the first weight coefficient (e.g., a₁) or the second weight coefficient (e.g., a₂) differently according to the characteristics of the image sensor 100 or the curvature of the lens. Equations 12 to 15 below may correspond to equations for the first weight coefficient (e.g., a₁) or the second weight coefficient (e.g., a₂) that the image processing device 200 may select. In one example, referring to FIGS. 3 and 12, the weight determiner 250 may determine the weights by applying the first weight coefficient (e.g., a₁) or the second weight coefficient (e.g., a₂) determined based on Equations 12 to 15 to Equations 2, 3, 6, and 7.

In one embodiment, the weight determiner 250 may determine the first weight coefficient (e.g., a₁) or the second weight coefficient (e.g., a₂) based on at least one of Equations 12 to 15. In Equations 12 to 15, a₁ may correspond to the first weight coefficient, a₂ may correspond to the second weight coefficient, e may correspond to an error calculated by the error calculator (e.g., the error calculator 240), X may correspond to the image size in the x-direction, Y may correspond to the image size in the y-direction, E may correspond to the search range of SAD, r₀ may correspond to a first correction coefficient specific to the image sensor (e.g., the image sensor 100), β may correspond to a second correction coefficient specific to the image sensor (e.g., the image sensor 100), ε may correspond to a third correction coefficient specific to the image sensor (e.g., the image sensor 100), θ may correspond to the angle of the vector connecting the centers of the reference kernel 1210 and the phase difference kernel 1240 with respect to the x-axis, and r may correspond to the distance from the center of the image. When the weight determiner 250 determines the first weight coefficient (e.g., a₁) or the second weight coefficient (e.g., a₂) based on at least one of Equation 12 or Equation 13, the weights calculated according to the first weight coefficient (e.g., a₁) or the second weight coefficient (e.g., a₂) may correspond to the preset weights described in FIG. 3.

$${a}_{1} := \{ \begin{matrix}- 1 , & y < 0 \\ 1 , & y \geq 0\end{matrix} \qquad [ Equation 12 ]$$

$${a}_{2} := \{ \begin{matrix}- 1 , & y \geq 0 \\ 1 , & y < 0\end{matrix}$$

$${a}_{1} := \frac{y}{Y} \qquad [ Equation 13 ]$$

$${a}_{2} := - \frac{y}{Y}$$

$${a}_{1} := \frac{y}{Y} \cdot \vert \frac{e}{E} \vert \qquad [ Equation 14 ]$$

$${a}_{2} := - \frac{y}{Y} \cdot \vert \frac{e}{E} \vert$$

$${a}_{1} := - \frac{ε}{\vert \frac{e}{E} \vert \cdot {( \frac{r - {r}_{0}}{r} )}^{β} + ε} sin ( θ ) \qquad [ Equation 15 ]$$

$${a}_{2} := \frac{ε}{\vert \frac{e}{E} \vert \cdot {( \frac{r - {r}_{0}}{r} )}^{β} + ε} sin ( θ )$$

In one embodiment, the image processing device 200 may substitute the error calculated by the error calculator (e.g., the error calculator 240) into the first weight coefficient (e.g., a₁) or the second weight coefficient (e.g., a₂) based on the relationship between the phase difference kernel 1240 and the reference kernel 1210 to correct the phase difference corresponding to the error. For example, the image processing device 200 may determine the value of the first weight coefficient (e.g., a₁) or the second weight coefficient (e.g., a₂) according to Equation 14 or Equation 15, and determine the first weight (e.g., W_{L1}), the second weight (e.g., W_{R1}), the third weight (e.g., W_{L2}), and the fourth weight (e.g., W_{R2}) based on the determined value of the first weight coefficient (e.g., a₁) or the second weight coefficient (e.g., a₂). The image processing device 200 may generate a corrected phase difference image based on the weighted pixel data.

In one embodiment, the image processing device 200 may substitute the noise variance of pixels or the analog gain of the image sensor 100 into the first weight coefficient (e.g., a₁) or the second weight coefficient (e.g., a₂) to correct the phase difference corresponding to the noise variance or the analog gain. In one example, the image processing device 200 may determine the value of the first weight coefficient (e.g., a₁) or the second weight coefficient (e.g., a₂) using machine learning. For example, the image processing device 200 may calculate the optimal weights to minimize the error by using a machine learning module stored in a memory or server for the feedback operation among the weight applicator (e.g., the weight applicator 220), the phase difference calculator (e.g., the phase difference calculator 230), the error calculator (e.g., the error calculator 240), and the weight determiner (e.g., the weight determiner 250).

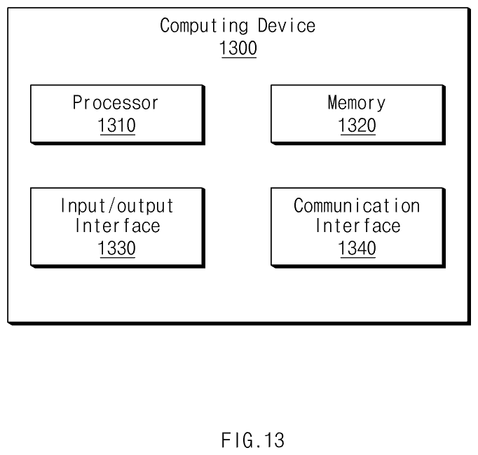

FIG. 13 is a block diagram illustrating an example of a computing device corresponding to the image processing device of FIG. 1.

Referring to FIG. 13, the computing device 1300 may represent an embodiment of a hardware configuration for performing the operation of the image processing device 200 of FIG. 1.

The computing device 1300 may be mounted on a chip that is independent from the chip on which the image sensing device is mounted. In one embodiment, the chip on which the image sensing device is mounted and the chip on which the computing device 1300 is mounted may be implemented in one package, for example, a multi-chip package (MCP), but other implementations are also possible.

Additionally, the internal configuration or arrangement of the computing device 1300 and the image sensing device may vary depending on the embodiment. For example, at least a portion of the image sensing device may be included in the computing device 1300. Alternatively, at least a portion of the computing device 1300 may be included in the image sensing device. In this case, at least a portion of the computing device 1300 may be mounted together on a chip on which the image sensing device is mounted.

The computing device 1300 may include a processor 1310, a memory 1320, an input/output interface 1330, and a communication interface 1340.

The processor 1310 may process data and/or instructions required to perform the operations of the components 110 and 120 of the image processing device 200 described in FIG. 1. That is, the processor 1310 may refer to the image processing device 200, but other implementations are also possible.

The memory 1320 may store data and/or instructions required to perform operations of the components 210, 220, and 230 of the image processing device 200, and may be accessed by the processor 1310. For example, the memory 1320 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), etc.), EEPROM (Electrically Erasable PROM), flash memory, etc.).

That is, the computer program for performing the operations of the image processing device 200 described in the present disclosure may be recorded in the memory 1320 and executed and processed by the processor 1310, thereby implementing the operations of the image processing device 200.

The input/output interface 1330 is an interface that connects an external input device (e.g., keyboard, mouse, touch panel, etc.) and/or an external output device (e.g., display) to the processor 1310 to allow data to be transmitted and received.

The communication interface 1340 is a component capable of transmitting and receiving various data to and from an external device (e.g., an application processor, external memory, etc.), and may be a device that supports wired or wireless communication.

As is apparent from the above description, by taking into account the characteristics of pixels using microlenses, the accuracy of phase-difference detection may be improved even when an error occurs between the phase difference detected by the pixel and the position of the lens.

The embodiments of the disclosed technology may provide a variety of effects capable of being directly or indirectly recognized through the above-mentioned patent document.

Those skilled in the art will appreciate that the disclosed technology may be carried out in other specific ways than those set forth herein. In addition, claims that are not explicitly presented in the appended claims may be presented in combination as an embodiment or included as a new claim by a subsequent amendment after the application is filed.

Although a number of illustrative embodiments have been described, it should be understood that modifications and enhancements to the disclosed embodiments and other embodiments can be devised based on what is described and/or illustrated in this patent document.

What is claimed is:

1. An image processing device, comprising:
an error calculator configured to calculate, for a first group of pixels, a first error of a first test phase difference based on a difference between the first test phase difference calculated based on the first group of pixels and a value corresponding to a lens position;
a weight determiner communicatively coupled to the error calculator to receive the first error from the error calculator and configured to determine a first group of weights corresponding to the first group of pixels based on the first error; and
a weight applicator communicatively coupled to the weight determiner to receive the first group of weights from the weight determiner and configured to apply the first group of weights to pixel data of the first group pixels.

2. The image processing device according to claim 1, wherein:
the first group of pixels shares a first microlens.

3. The image processing device according to claim 2, wherein:
the first group of pixels includes first to fourth pixels,
wherein:
the first pixel is positioned in a first channel corresponding to an upper left side of the first microlens;
the second pixel is positioned in a second channel corresponding to an upper right-side of the first microlens;
the third pixel is positioned in a third channel corresponding to a lower left side of the first microlens; and
the fourth pixel is positioned in a fourth channel corresponding to a lower right side of the first microlens.

4. The image processing device according to claim 1, further comprising:
a phase difference calculator configured to:
identify a plurality of images having different phases based on the first group of pixels; and
calculate a phase difference based on the plurality of images having the different phases.

5. The image processing device according to claim 4, wherein:
the plurality of images having the different phases includes a left-right phase difference image or an up-down phase difference image of an incident image.

6. The image processing device according to claim 4, wherein:
the phase difference calculator is configured to calculate a corrected phase difference based on pixel data obtained by applying the first group of weights to the pixel data of the first group of pixels.

7. The image processing device according to claim 6, wherein:
the phase difference calculator is further configured to transmit a lens control signal that is generated based on the corrected phase difference to adjust the lens position.

8. The image processing device according to claim 4, wherein:
the phase difference calculator is further configured to calculate the phase difference based on a sum of absolute difference (SAD) method or a sum of squared difference (SSD) method.

9. The image processing device according to claim 4, wherein:
the phase difference calculator is further configured to calculate a second test phase difference based on a second group of pixels;
the error calculator is further configured to calculate a second error of the second test phase difference based on a difference between a value corresponding to the second test phase difference and the value corresponding to the lens position;
the weight determiner is further configured to determine a second group of weights corresponding to the second group of pixels based on the second error; and
the weight applicator is further configured to apply the second group of weights to pixel data of the second group of pixels.

10. The image processing device according to claim 9, wherein:
the second group of pixels includes fifth to eighth pixels sharing a second microlens,
wherein:
the fifth pixel is positioned in a first channel of the second microlens,
the sixth pixel is positioned in a second channel of the second microlens,
the seventh pixel is positioned in a third channel of the second microlens, and
the eighth pixel is positioned in a fourth channel of the second microlens.

11. The image processing device according to claim 9, wherein:
the weight determiner is further configured to determine a third group of weights applied to a third group of pixels based on the first group of weights and the second group of weights.

12. The image processing device according to claim 1, wherein:
the first error is a linearity error indicating that a linear relationship between the value corresponding to the first test phase difference and the value corresponding to the lens position.

13. The image processing device according to claim 1, wherein:
the weight determiner is further configured to determine at least one of the first group of weights based on noise of the pixel data of the first group of pixels.

14. The image processing device according to claim 1, wherein:
the weight determiner is further configured to determine at least one of the first group of weights based on an analog gain of the image processing device.

15. An image processing device, comprising:
an error calculator configured to calculate a first error of a first test phase difference based on phase difference data and lens position information;
a weight determiner in communication with the error calculator to receive the first error and configured to determine first to fourth weights based on the first error; and
a weight applicator in communication with the weight determiner to receive the first to fourth weights and configured to:
apply the first weight to pixel data of a first pixel;
apply the second weight to pixel data of a second pixel;
apply the third weight to pixel data of a third pixel; and
apply the fourth weight to pixel data of a fourth pixel.

16. A method for processing an image signal, the method comprising:
calculating a test phase difference based on pixel data of a plurality of pixels;
calculating an error based on a difference between a value corresponding to the test phase difference and a value corresponding to a lens position;
determining a weight based on the error; and
applying the weight to pixel data of the plurality of pixels.

17. The method according to claim 16, further comprising:
calculating a corrected phase difference based on pixel data obtained by applying the weight to the pixel data of the plurality of pixels.

18. The method according to claim 17, wherein the calculating the corrected phase difference includes:
calculating a left-right phase difference or an up-down phase difference based on the pixel data obtained by applying the weight to the pixel data of the plurality of pixels.

19. The method according to claim 16, wherein:
the plurality of pixels shares at least one microlens.

20. The method according to claim 19, wherein:
the at least one microlens corresponds to an array of pixels arranged in a plurality of rows and a plurality of columns.
